(19) United States
(12) Patent Application Publication
(10) Pub. No.: US 2014/0092855 A1
(43) Pub. Date: Apr. 3, 2014

(54) APPARATUS AND METHOD FOR PERFORMING RANDOM ACCESS IN WIRELESS COMMUNICATION SYSTEM

(71) Applicants: Jae Hyun Ahn, Seoul (KR); Ki Bum Kwon, Seoul (KR)

(72) Inventors: Jae Hyun Ahn, Seoul (KR); Ki Bum Kwon, Seoul (KR)

(73) Assignee: Pantech Co., Ltd, Seoul (KR)

(21) Appl. No.: 14/119,733

(22) PCT Filed: Jun. 21, 2012
(86) PCT No.: PCT/KR2012/004902

§ 371 Date: Nov. 22, 2013

(30) Foreign Application Priority Data
Jun. 23, 2011 (KR) 10-2011-0061233
Aug. 18, 2011 (KR) 10-2011-0082466

(51) Int. Cl. H04W 74/08

(52) U.S. Cl. CPC H04W 74/0833
USPC 370/329

(57) ABSTRACT

Disclosed are a method and an apparatus for performing a random access by a user equipment in. The method includes transmitting a random access preamble to an evolved-NodeB (eNB) on at least one serving cell; and receiving a random access response message as a response to the random access preamble from the eNB, wherein the random access response message is transmitted through a physical downlink shared channel (PDSCH) ordered by a physical downlink control channel (PDCCH) scrambled by the at least one random access radio network temporary identifier (RA-RNTI) for the at least one serving cell, respectively. The UE can receive timing information for uplink synchronization through a plurality of serving cells to perform the uplink synchronization with the eNB and more effectively configure the random access response message transmitted from the eNB to the UE for uplink synchronization.

### CROSS-REFERENCE TO RELATED APPLICATIONS

This application is the National Stage Entry of International Application PCT/KR2012/004902, filed on Jun. 21, 2012, and claims priority and the benefit of Korean Patent Application No. 10-2011-0061233, filed on Jun. 23, 2011 and Korean Patent Application No. 10-2011-0082466, filed on Aug. 18, 2011, all of which are incorporated herein by reference in their entireties for all purposes as if fully set forth herein.

### BACKGROUND

1. Field

The present invention relates to wireless communications, and more particularly, to an apparatus and a method for performing a random access in a wireless communication system.

2. Discussion of the Background

In a typical wireless communication system, even though a bandwidth of an uplink and a bandwidth of a downlink are differently set from each other, only one carrier has been mainly considered. Even in 3rd generation partnership project (3GPP) long term evolution (LTE), the number of carriers configuring an uplink and a downlink is one and a bandwidth of an uplink and a bandwidth of a downlink are generally symmetrical to each other, based on a single carrier. In a single carrier system, a random access is performed using a single carrier. However, with the recent introduction of a multiple carrier system, the random access may be performed by several component carriers.

The multiple carrier system means a wireless communication system that can support carrier aggregation. The carrier aggregation, which is a technology for efficiently using a small piece of band, is to exhibit an effect like using logically large bands acquired by bundling a plurality of physically non-continuous bands in a frequency domain.

In order to access a user equipment (UE) to a network, a random access process is performed. The random access process may be divided into a contention based random access procedure and a non-contention based random access procedure. The biggest difference between the contention based random access process and the non-contention based random access process is on whether a random access preamble is designated as dedication to a single UE. Since the UE uses the dedicated random access preamble designated thereto during the non-contention based random access process, the UE does not content (or collision) with another user equipment. Here, the contention means that at least two UEs attempt the random access process through the same resource using the same random access preamble. Since the UE uses an arbitrarily selected random access preamble during the contention based random access process, the contention possibility is present.

As an object of allowing the UE to perform the random access process to the network, there may be an initial access, a handover, a scheduling request, timing alignment, and the like.

### SUMMARY

The present invention provides an apparatus and a method for performing a random access in a wireless communication system.

The present invention also provides an apparatus and a method for performing a random access capable of setting and transmitting random access wireless network temporary identifiers for at least one secondary serving cells for applying timing advance to at least one secondary serving cell.

The present invention also provides an apparatus and a method for transmitting an access response message including a media access random control (MAC) component having a variable length.

In an aspect, a method for performing a random access by a user equipment (UE) in a wireless communication system is provided. The method includes: transmitting a random access preamble to an evolved-NodeB (eNB) on at least one serving cell; and receiving a random access response message as a response to the random access preamble from the eNB, wherein the random access response message is transmitted through a physical downlink shared channel (PDSCH) ordered by a physical downlink control channel (PDCCH) scrambled based on the at least one random access radio network temporary identifier (RA-RNTI) for at least one serving cell, respectively.

The at least one RA-RNTI may be set to have different values for the at least one serving cell using an offset value.

The random access response message may include a media access control (MAC) component including a plurality of timing advance command information.

The random access response message may include an MAC sub-header including length related information of the MAC component.

In another aspect, a user equipment performing a random access in a wireless communication system is provided. The user equipment includes: a transmitting unit that transmits a random access preamble to an evolved-NodeB (eNB) on at least one serving cell; and a receiver unit that receives a random access response message as a response to the random access preamble from the eNB, wherein the random access response message is transmitted through a physical downlink shared channel (PDSCH) ordered by a physical downlink control channel (PDCCH) scrambled based on the at least one random access radio network temporary identifier (RA-RNTI) for the at least one serving cell, respectively.

In still another aspect, a method for performing a random access by an evolved-NodeB (eNB) in a wireless communication system is provided. The method includes: receiving a random access preamble from a user equipment (UE) on at least one serving cell; and transmitting a random access response message as a response to the random access preamble to the eNB, wherein the random access response message is transmitted through a physical downlink shared channel (PDSCH) ordered by a physical downlink control channel (PDCCH) scrambled based on the at least one random access radio network temporary identifier (RA-RNTI) for the at least one serving cell, respectively.

In still yet another aspect, an evolved-NodeB (eNB) performing a random access in a wireless communication system is provided. The eNB includes: a receiving unit that receives a random access preamble to a user equipment (UE) on at least one serving cell; a processor that configures a random access response message as a response to the random access preamble; and a transmitting unit that transmits the random access response message to the UE, wherein the random access response message is transmitted through a physical downlink shared channel (PDSCH) ordered by a physical downlink control channel (PDCCH) scrambled based on the at least one random access radio network temporary identifier (RA-RNTI) for the at least one serving cell, respectively.

According to the exemplary embodiments of the present invention, it is possible for the UE to perform the uplink synchronization with the evolved-NodeB (eNB) by receiving the timing information for the uplink synchronization through the plurality of serving cells.

According to the exemplary embodiments of the present invention, it is possible for the eNB to more efficiently configure the random access response message transmitted to the UE so as to perform the uplink synchronization.

According to the exemplary embodiments of the present invention, it is possible to set and transmit the differentiated random access wireless network temporary identifiers for the plurality of serving cells.

According to the exemplary embodiments of the present invention, it is possible to reduce the overhead and the complexity through the signaling using the MAC component of the random access response message.

### BRIEF DESCRIPTION OF DRAWINGS

FIG. 1 is a diagram showing a wireless communication system to which an exemplary embodiment of the present invention is applied.

FIG. 2 is a diagram showing an example of a protocol structure for supporting multi-carriers to which an exemplary embodiment of the present invention is applied.

FIG. 3 is a diagram showing an example of a frame structure for a multi-carrier operation to which an exemplary embodiment of the present invention is applied.

FIG. 4 is a diagram showing linkage between downlink component carriers and uplink component carriers in a multi-carrier system to which an exemplary embodiment of the present invention is applied.

FIG. 5 is a diagram showing an example of timing advance during a synchronization process to which an exemplary embodiment of the present invention is applied.

FIG. 6 is a diagram showing a case of applying an uplink timing alignment value using downlink timing alignment values of primary serving cells and secondary serving cells.

FIG. 7 is a flow chart for describing a method for performing a random access for applying multi-TA.

FIG. 8 is another flow chart for describing a method for performing a random access for applying multi-TA.

FIG. 9 is a flow chart for describing a random access procedure according to an exemplary embodiment of the present invention.

FIG. 10 is a flow chart for describing a random access procedure according to another exemplary embodiment of the present invention.

FIG. 11 is a diagram showing an example of a RAPID MAC sub-header included in a random access response message according to an exemplary embodiment of the present invention.

FIG. 12 is a diagram showing another example of a RAPID MAC sub-header included in a random access response message according to an exemplary embodiment of the present invention.

FIG. 13 is a diagram showing another example of an MAC sub-header included in a random access response message according to an exemplary embodiment of the present invention.

FIG. 14 is a diagram showing another example of an MAC sub-header included in a random access response message according to an exemplary embodiment of the present invention.

FIG. 15 is a diagram showing another example of an MAC sub-header included in a random access response message according to an exemplary embodiment of the present invention.

FIG. 16 is a diagram showing an example of a structure of an MAC component included in a random access response message according to an exemplary embodiment of the present invention.

FIG. 17 is a diagram showing another example of a structure of an MAC component included in a random access response message according to an exemplary embodiment of the present invention.

FIG. 18 is a diagram showing another example of a structure of an MAC component included in a random access response message according to an exemplary embodiment of the present invention.

FIG. 19 is a diagram showing an MAC PDU structure for random access response and a mapping structure of RAPID and random access response.

FIG. 20 is a diagram showing an operation flow chart of a UE performing a random access procedure according to an exemplary embodiment of the present invention.

FIG. 21 is a diagram showing an operation flow chart of an eNB performing a random access procedure according to an exemplary embodiment of the present invention.

FIG. 22 is a block diagram showing an eNB and a UE performing a random access according to an exemplary embodiment of the present invention.

### DETAILED DESCRIPTION OF THE ILLUSTRATED EMBODIMENTS

Hereinafter, some exemplary embodiments in the present invention will be described in detail with reference to the illustrative drawings. It is to be noted that in adding reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

In addition, in describing components of the present specification, terms such as first, second, A, B, (a), (b), etc. may be used. These terms are used only to differentiate the components from other components. Therefore, the nature, times, sequence, etc. of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

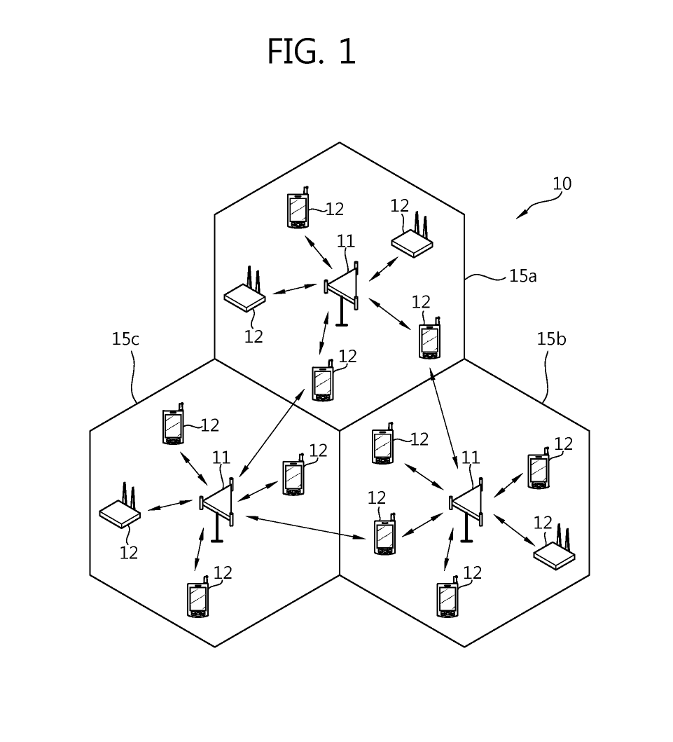

FIG. 1 is a diagram showing a wireless communication system to which an exemplary embodiment of the present invention is applied.

Referring to FIG. 1, a wireless communication system 10 is widely distributed to provide various communication services such as voice, packets, data, and the like. The wireless communication system 10 includes at least one evolved-NodeB (eNB) 11. Each eNB 11 provides communication services to specific cells 15a, 15b, and 15c. The cells may be again divided into a plurality of regions (referred to as sectors).

A UE (UE) 12 may be fixed or may have mobility and may be referred to other terms such as a mobile station (MS), a mobile terminal (MT), a user terminal (UT), a subscriber station (SS), a wireless device, a personal digital assistant (PDA), a wireless modem, a handheld device, and the like. The eNB 11 may be referred to as other terms such as a base station (BS), a base transceiver system (BTS), an access point, a femto base station, a home nodeB, a relay, and the like. The cell needs to be construed as comprehensive meaning indicating a partial region covered by the eNB 11 and has a meaning covering all of various coverage regions such as a mega cell, a macro cell, a micro cell, a pico cell, a femto cell, and the like.

Hereinafter, downlink means communication from the eNB 11 to the UE 12 and uplink means communication from the UE 12 to the eNB 11. A transmitter in the downlink may be a portion of the eNB 11 and a receiver therein may be a portion of the UE 12. A transmitter in the uplink may be a portion of the UE 12 and a receiver therein may be a portion of the eNB 11. Multiple access techniques applied to a wireless communication system is not limited. Various multiple access techniques such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, OFDM-CDMA, and the like, may be used. A time division duplex (TDD) type performing uplink transmission and downlink transmission at different time may be used. Alternatively, a frequency division duplex (FDD) type performing the uplink transmission and the downlink transmission at different frequencies may be used.

The carrier aggregation (CA) supports a plurality of carriers and is referred to as spectrum aggregation or bandwidth aggregation. An individual unit carrier that is bundled by the carrier aggregation is referred to as a component carrier (CC). Each component carrier is defined as a bandwidth and a central frequency. The carrier aggregation has been introduced to support increased throughput and prevents cost increase due to the introduction of a broadband radio frequency (RF) device and secure compatibility with the existing systems. For example, when five component carriers are assigned as granularity in a carrier unit having a bandwidth of 20 MHz, the carrier aggregation can support at a maximum of bandwidth of 100 Mhz.

The carrier aggregation may be divided into contiguous carrier aggregation performed among continuous component carriers and non-contiguous carrier aggregation performed among non-continuous component carriers, in a frequency domain. The number of carriers aggregated between the downlink and the uplink may be differently set. A case in which the number of downlink component carriers is the same as the number of uplink component carriers is a referred to as symmetric aggregation and a case in which the number of downlink component carriers is different from the number of uplink component carriers is a referred to as asymmetric aggregation.

A magnitude (that is, a bandwidth) of the component carriers may be different from each other. For example, if it is assumed that five component carriers for configuring a band of 70 MHz is used, they may be configured like 5 MHz component carrier (carrier #0)+20 MHz component carrier (carrier #1)+20 MHz component carrier (carrier #2)+20 MHz component carrier (carrier #3)+5 MHz component carrier (carrier #4).

Hereinafter, a multiple carrier system means a system that supports the carrier aggregation. In the multiple carrier system, the contiguous carrier aggregation and/or the non-contiguous carrier aggregation may be used. Further, any of the symmetric aggregation and the asymmetric aggregation may be used.

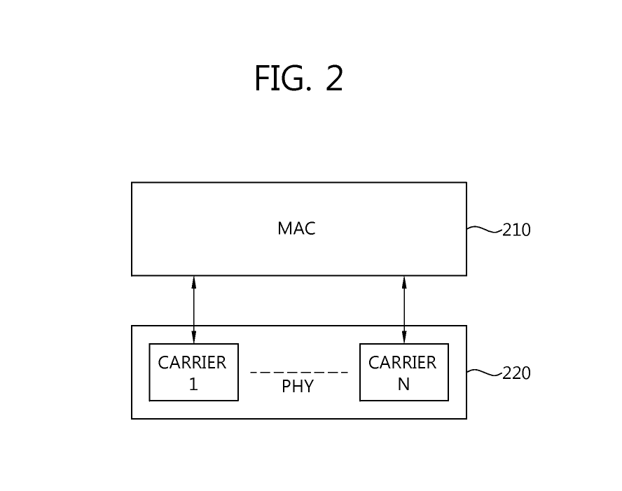

FIG. 2 is a diagram showing an example of a protocol structure for supporting multi-carriers to which an exemplary embodiment of the present invention is applied.

Referring to FIG. 2, a common medium access control (MAC) entity 210 manages a physical layer 220 using a plurality of carriers. An MAC management message transmitted at a specific carrier may be applied to other carriers. That is, the MAC management message is a message that can control other carriers, including the specific carrier. The physical layer 220 may be operated depending on the time division duplex (TDD) and/or the frequency division duplex (FDD).

There are several physical control channels used for the physical layer 220. A physical downlink control channel (PDCCH) informs the UE of resource assignment of a paging channel (PCH) and a downlink shared channel (DL-SCH) and hybrid automatic repeat request (HARQ) information associated with the DL-SCH. The PDCCH may carry uplink grant informing the resource assignment of the uplink transmission to the UE. A physical control format indicator channel (PCFICH) informs the UE of the number of OFDM symbols used for the PDCCHs and is transmitted for each sub-frame. A physical hybrid ARQ indicator channel (PHICH) carries an HARQ ACK/NAK signal as a response of the uplink transmission. A physical uplink control channel (PUCCH) carries the HARQ ACK/NAK for the downlink transmission, a scheduling request, and uplink control information such as CQI. A physical uplink shared channel (PUSCH) carries an uplink shared channel (UL-SCH). A physical random access channel (PRACH) carries a random access preamble.

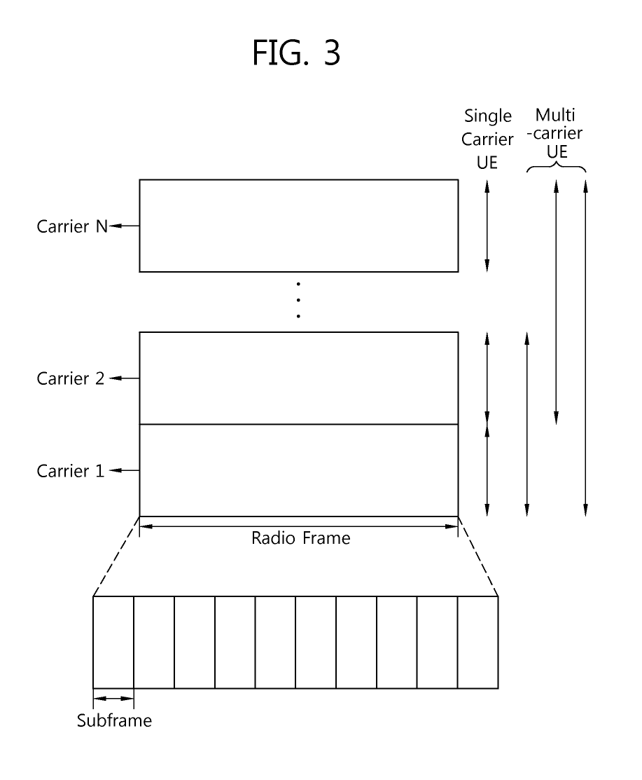

FIG. 3 is a diagram showing an example of a frame structure for a multi-carrier operation to which an exemplary embodiment of the present invention is applied.

Referring to FIG. 3, a frame is configured of 10 sub-frames. The sub-frame includes a plurality of OFDM symbols. Each carrier may have their own control channels (for example, PDCCH). The multi-carriers may be contiguous to each other and may not be contiguous to each other. The UE may support more than one carrier according to its own role.

The component carrier may be divided into a primary component carrier (PCC) and a secondary component carrier (SCC) according to activation or not. The primary component carrier is a carrier that is always activated and the secondary component carrier is a carrier that is activated/deactivated according to specific conditions. The activation means that traffic data can be transmitted or received or are in a ready state. The deactivation means that the traffic data cannot be transmitted or received and measurement can be performed or minimum information can be transmitted/received. The UE uses only a single primary component carrier and may use more than one secondary component carrier together with the primary component carrier. The UE may be assigned with the primary component carrier and/or the secondary component carrier from the eNB.

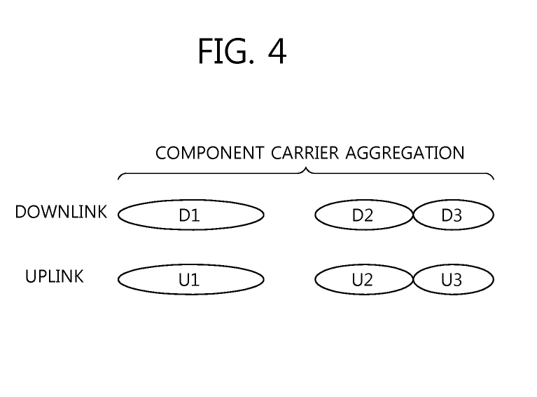

FIG. 4 is a diagram showing linkage between a downlink component carrier and an uplink component carrier in a multi-carrier system to which an exemplary embodiment of the present invention is applied.

Referring to FIG. 4, downlink component carriers D1, D2, and D3 are aggregated in the downlink and uplink component carriers U1, U2, and U3 are aggregated in the uplink. Here, Di is an index of the downlink component carrier and Ui is an index of the uplink component carrier (i=1, 2, 3). At least one downlink component carrier is the primary component carrier and the rest are the secondary component carrier. Similarly, at least one uplink component carrier is the primary component carrier and the rest are the secondary component carrier. For example, D1 and U1 are the primary component carrier and D2, U2, D3, and U3 are the secondary component carrier.

In the FDD system, the downlink component carriers and the uplink component carriers are connection-established one-to-one. For example, D1, D2, and D3 are connection-established with U1, U2, and U3 one-to-one. The UE performs the linkage between the downlink component carriers and the uplink component carriers through system information transmitted by the logical channel BCCH or the UE dedicated RRC message transmitted by the DCCH. Each linkage may be established cell-specifically or a UE-specifically.

FIG. 4 shows only the one-to-one linkage between the downlink component carrier and the uplink component carrier by way of example, but 1:n or n:1 linkage may be established. In addition, the index of the component carrier does not correspond to a sequence of the component carriers or a position of frequency bands of the corresponding component carriers.

The UE that is a radio resource control (RRC) idle mode cannot perform the component carrier aggregation and perform the component carrier aggregation only in the RRC connection mode to which the radio resource control is connected. Prior to the component carrier aggregation, the UE for the radio resource control connection selects one cell based on several conditions. The cell selection conditions of the UE are as follows.

First, the UE may select the most suitable cell that attempts the RRC connection based on measured information. The UE considers both of reference signal receiving power (RSRP) measuring received power based on a cell-specific reference signal (CRS) of the received specific cell and reference signal receiving quality (RSRQ) defined by a ratio of the entire received power to the RSRP value for the specific cell, as the measured information. Therefore, the UE acquires the RSRP and RSRQ values for each distinguishable cell and thus, selects the suitable cells based on the acquired RSRP and RSRQ values. For example, both of the RSRP and RSRQ values have a value of 0 dB or more, weights are assigned (for example, 7:3) to a cell in which the RSRP value is maximal or a cell in which the RSRQ value is maximal or each of the RSRP and RSRQ values, and the suitable cell may be selected based on an average value considering the weights.

Second, in a system that is stored in a UE internal memory, the radio resource control connection may be attempted using information on a public land mobile network (PLMN) that is fixedly set, downlink central frequency information, or cell differentiation information (for example, physical cell ID (PCI)). The stored information may configure of the information on a plurality of public land mobile networks and cells and priority or preferred weights may be set to each information.

Third, the UE receives system information through a broadcast channel (BCH) from the eNB and confirms the received system information, thereby attempting the radio resource control connection. For example, the UE confirms whether the specific cell (for example, closed subscribe group (CSG), non-allowed Home eNB, and the like) requires membership for cell connection. Therefore, the UE receives the system information transmitted by each eNB to confirm CSG ID information indicating the CSG or not. Further, in the case of the CSG, it confirms an accessible CSG or not. In order to confirm accessibility, the UE may use its own membership information and unique information (for example, evolved-cell global ID (E-CGI) or PCI information) of the CSG cell. When the eNB is confirmed as a non-accessible eNB through the confirmation procedure, the radio resource control connection is not attempted.

Fourth, the radio resource control connection can be attempted through the valid component carriers (for example, the component carriers that can be configured within a supportable frequency band on implementation by the UE) that are stored in the internal memory of the UE.

The second and fourth conditions among the selection conditions can be optionally applied but the first and third conditions need to be mandatorily applied.

In order to attempt the radio resource control connection through the cell selected for the RRC connection, the UE needs to confirm the uplink band transmitting the RRC connection request message. Therefore, the UE receives the system information through a broadcasting channel transmitted through the downlink of the selected cell. System information block 2 (SIB2) includes bandwidth information and central frequency information on the band to be used as the uplink. Therefore, the UE attempts the RRC connection through the uplink band that is connection-established through the downlink of the selected cell and the information within the SIB2. In this case, the UE can transmit the RRC connection request message to the eNB during the random access procedure.

When the RRC connection procedure is successful, the RRC established cell may be referred to as the primary serving cell, wherein a primary serving cell is configured of the downlink primary component carriers and the uplink primary component carriers.

The primary serving cell means a single serving cell that provides security input and non-access stratum (NAS) mobility information, in the state of RRC establishment or re-establishment. According to capabilities of the UE, at least one cell may be configured to form a set of the serving cells together with the primary serving cells, wherein the at least one cell is referred to as a secondary serving cell.

Therefore, the set of the serving cells established for one UE may be configured of only one primary serving cell or may be configured of one primary serving cell and at least one secondary serving cell.

The downlink component carrier corresponding to the primary serving cell is referred to as the downlink primary component carrier (DL PCC) and the uplink component carrier corresponding to the primary serving cell is referred to as the uplink primary component carrier (UL PCC). In addition, in the downlink, the component carrier corresponding to the secondary serving cell is referred to as the downlink secondary component carrier DL SCC and in the uplink, the component carrier corresponding to the secondary serving cell is referred to as the uplink secondary component carrier UL SCC. Only the downlink component carrier may correspond to a single serving cell and the DL CC and the UL CC may correspond thereto.

Therefore, in the carrier system, the case in which the communication between the UE and the eNB is performed through the DL CC or the UL CC is equivalent to the case in which communication between the UE and the eNB is performed through the serving cell. For example, in a method for performing a random access according to an exemplary embodiment of the present invention, the case in which the UE transmits the preamble using the UL CC is equivalent to the case in which the UE transmits the preamble using the primary serving cell or the secondary serving cell. In addition, the case in which the UE receives the downlink information using the DL CC is equivalent to the case in which the UE receives the downlink information using the primary serving cell or the secondary serving cell.

Meanwhile, the primary serving cell and the secondary serving cell have the following characteristics.

First, the primary serving cell is used to transmit the PUCCH. On the other hand, the secondary serving cell may not transmit the PUCCH but may transmit some control information among the information within the PUCCH through the PUSCH.

Second, the primary serving cells are activated at all times, while the secondary serving cell is a carrier that is activated/deactivated according to the specific conditions. The specific conditions may be the case in which the activation/deactivation MAC component messages of the eNB are received or a deactivated timer within the UE is expired.

Third, when the primary serving cell experiences radio link failure (hereinafter, referred to as RLF), the RRC re-establishment is triggered or when the secondary serving cell experience the RLF, the RRC re-establishment is not triggered. The radio link failure occurs when the downlink performance is kept at a threshold or less for predetermined time or when a random access channel (RACH) has failed by the number of times beyond the threshold.

Fourth, the primary serving cell may be changed by a change in a security key or a handover procedure accompanied by the RACH procedure. However, in the case of a contention resolution (CR) message, only the downlink control channel (PDCCH) indicating the CR needs to be transmitted through the primary serving cell and the CR information may be transmitted through the primary serving cell or the secondary serving cell.

Fifth, the NAS information is received through the primary serving cell.

Sixth, the primary serving cell is configured in a pair of the DL PCC and the UL PCC at all times.

Seventh, other CCs for each UE may be established as the primary serving cell.

Eighth, procedures such as reconfiguration, adding, and removal of the secondary serving cell may be performed by a radio resource control (RRC) layer. In adding a new secondary serving cell, the RRC signaling may be used to transmit the system information of a dedicated secondary serving cell.

Ninth, the primary serving cell may provide both of the PDCCH (for example, downlink assignment information or uplink grant information) assigned to a UE-specific search space established to transmit the control information to a specific UE within a region transmitting the control information and the PDCCH (for example, system information (SI), random access response (RAR), transmit power control (TPC)) assigned to common search space established to transmit the control information to the plurality of UEs meeting all the UES or the specific condition within the cell. On the other hand, the secondary serving cell may establish only the UE-specific search space. That is, the UE cannot confirm the common search space through the secondary serving cell and therefore, cannot receive the control information transmitted only through the common search space and the data information indicating the control information.

The technical idea of the present invention regarding the characteristic of the primary serving cell and the secondary serving cell is not necessarily limited to the above description but is described by way of example only and may include more examples.

Meanwhile, in the wireless communication environment, a radio wave is propagated from a transmitter and thus, propagation delay is experienced during the transmission of the radio wave from the receiver. Therefore, even though both of the transmitter and receiver know the timing when the radio wave is propagated from the transmitter, the timing when the signal arrives at the receiver is affected by a distance between the transmitter and the receiver, neighboring propagation environment, and the like and when the receiver moves, the signal is changed over time. When the receiver cannot accurately know the timing when the signal transmitted from the transmitter is received, the receiver does not receive the signal or even though the receiver receives the signal, the receiver receives the distorted signal and thus, communication cannot be performed.

Therefore, in spite of the downlink/uplink in the wireless communication system, synchronization between the eNB and the UE is necessarily preconditioned so as to receive the information signal. A type of synchronization may include frame synchronization, information symbol synchronization, sampling period synchronization, and the like. The sampling period synchronization is synchronization that needs to be most basically acquired so as to differentiate the physical signal.

The downlink synchronization acquisition is performed in the UE based on the signal from the eNB. The eNB transmits the mutually promised specific signal so as to easily acquire the downlink synchronization in the UE. The UE needs to accurately differentiate the timing when the specific signal transmitted from the eNB is transmitted. In the case of the downlink, the single eNB simultaneously transmits the same synchronization signal to the plurality of UEs and therefore, the UEs each can independently acquire the synchronization.

In the case of the uplink, the eNB receives the signal transmitted from the plurality of UEs. When a distance between each UE and the eNB is different, the signals received by each eNB have different transmission delay time and when the uplink information is transmitted based on the acquired downlink synchronization, the information of each UE is received by the corresponding eNB at different time. In this case, the eNB cannot acquire the synchronization based on any one UE. Therefore, the uplink synchronization acquisition needs a procedure different from the downlink.

Meanwhile, the uplink synchronization acquisition may be different according to the multiple access types. For example, in the case of the CDMA system, even though the eNB receives the uplink signals of different UEs at different time, the eNB may separate each uplink signal. However, in the wireless communication system based on the OFDMA or the FDMA, the eNB simultaneously receives the uplink signals of all the UEs and demodulates the received uplink signals at a time. Therefore, as the uplink signals of the plurality of UEs are received at the accurate time, the receiving performance is increased and as the difference in the receiving time of each UE signal is increased, the receiving performance is suddenly deteriorated. Therefore, the uplink synchronization acquisition may be essential.

The random access procedure is performed to acquire the uplink synchronization and the UE acquires the uplink synchronization based on the timing alignment value transmitted from the eNB during the random access process. This is referred to as timing advance (TA). The time advance is referred to as timing alignment. When the uplink synchronization is acquired based on the timing alignment value and then, predetermined time lapses, it is determined that the acquired uplink synchronization is valid To this end, the UE defines a time alignment timer (TAT) that can be configured by the eNB and when being expired, starts the uplink synchronization acquisition procedure. When the time alignment timer is operated, both of the UE and the eNB are in the state in which the uplink synchronization is performed. When the time alignment timer is expired or is not operated, the UE and the eNB are in the state in which the synchronization is not made and the UE does not perform the uplink transmission other than the random access preamble transmission. The time alignment timer is operated in detail as follows.

i) When the UE receives a timing advance command through the MAC component from the eNB, the UE applies the timing alignment value indicating the received timing advance command to the uplink synchronization. Further, the UE starts or re-starts the time alignment timer.

ii) When the UE receives the timing advance command through the random access response message from the eNB, if the random access response message is not selected from the MAC layer of the UE (a), the UE applies the timing alignment value indicating the timing advance command to the uplink synchronization and the time alignment timer starts or re-starts. Alternatively, when the UE receives the timing advance command through the random access response message from the eNB, if the random access response message is selected from the MAC layer of the UE and the time alignment timer is not operated (b), the UE applies the timing alignment value indicating the timing advance command to the uplink synchronization and the time alignment timer starts and when a contention resolution that is the following random access process has failed, the time alignment timer stops. Alternatively, the case other than (a) and (b), the UE disregards the timing advance command.

iii) When the time alignment timer is expired, the UE flushes data stored in all the HARQ buffers. Further, the UE informs the RRC layer of the release of the PUCCH/SRS. In this case, when the SRS (periodic SRS) of type 0 is released and the SRS (aperiodic SRS) of type 1 is not released. The UE clears all the configured uplink and downlink resource assignment.

When the uplink synchronization is acquired, the UE starts the time alignment timer. When the time alignment timer is operated, both of the UE and the eNB are in the state in which the uplink synchronization is performed. When the time alignment timer is expired or is not operated, the UE and the eNB are in the state in which the synchronization is not made and the UE does not perform the uplink transmission other than the random access preamble transmission.

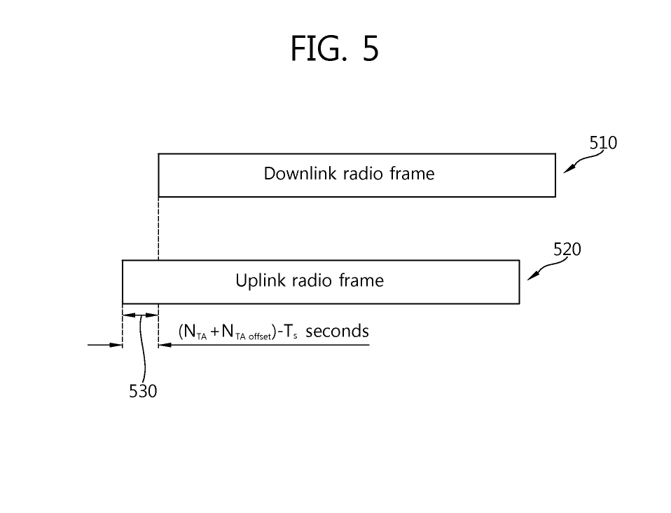

FIG. 5 is a diagram showing an example of timing advance during a synchronization process to which an exemplary embodiment of the present invention is applied.

Referring to FIG. 5, there is a need to transmit an uplink radio frame 520 at the timing when a downlink radio frame 510 is transmitted for communication between the eNB and the UE. Considering the time difference occurring due to the propagation delay between the UE and the eNB, the UE transmits the uplink radio frame 520 at the earlier timing than the timing when the UE transmits the downlink radio frame 510 to apply the timing advance so as to meet the synchronization between the eNB and the UE.

The timing TA when the UE adjusts the uplink time, the timing TA may be obtained by the following Equation 1.

TA=(N_{TA}+N_{TA offset})×Tₛ [Equation ]

In the above Equation, N_{TA} is the timing alignment value and is variably controlled by the timing advance command of the eNB and N_{TA offset} is a fixed value by the frame structure. Tₛ is a sampling period. Here, the timing alignment value N_{TA} is positive (+), which indicates that adjustment is performed so that the uplink time is advanced and the N_{TA} is negative (−), which indicates that adjustment is performed so that the uplink time is delayed.

For the uplink synchronization, the UE receives the TA value provided by the eNB and applies the timing advance using the received TA value and the UE can acquire synchronization for the wireless communication with the eNB.

Hereinafter, application of multiple timing advance (MTA) will be described.

In the multiple carrier system, the single UE performs communication with the eNB through the plurality of component carriers or the plurality of serving cells. When the signals of the plurality of serving cells established in the UE have different time delays, the UE needs to apply different TA to each serving cell.

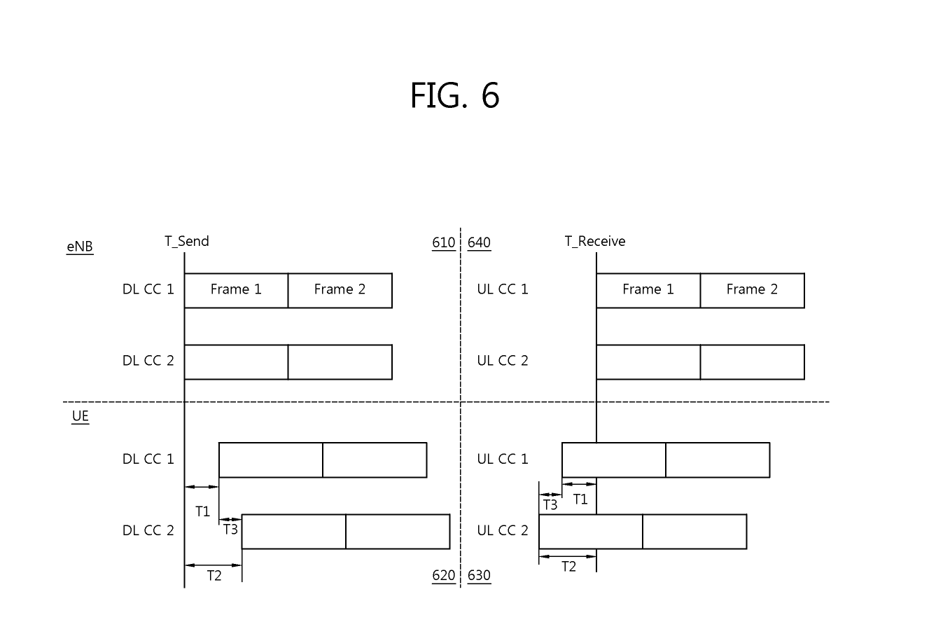

FIG. 6 is a diagram showing a case of applying the uplink timing alignment value using the downlink timing alignment value of the primary serving cell and the secondary serving cell. DL CC1 and UL CC1 are the primary serving cells and DL CC2 and UL CC2 are the secondary serving cells.

Referring to FIG. 6, when the eNB transmits the frame through the DL CC1 and the DL CC2 at T_Send timing (610), the UE receives the frame through the DL CC1 and DL CC2 (620). The UE receives the frame late as much as the propagation delay time after the T_Send timing transmitted by the eNB. In the DL CC1, the propagation delay is generated by T1 and the frame is received late as much as T1 and in the DL CC2, the propagation delay is generated by T2 and the frame is received late as much as T2.

If it is assumed that the propagation delay time of the downlink transmission is equal to the propagation delay time of the uplink transmission, the UE applies TA as much as T1 and T2 to the UL CC1 and UL CC2, respectively and can transmit the frame to the eNB (630). As a result, the eNB may receive the frame transmitted by the UE through the UL CC1 and the UL CC2 at T_Receive timing set for the uplink synchronization (S640).

The above description assumes the case in which the eNB receives the UL CC1 and the UL CC2 through a single receiving apparatus. Therefore, when the eNB configures the apparatus that can independently receive each UL CC, the T_Receive timing set by the eNB is not necessarily equal to all the UL CCs. That is, the T_Receive timing may be set for each UL CC. However, the arrival time of the uplink frame transmitted by the UEs using each UL CC needs to be equal to each T_Receive timing set for each UL CC.

The deactivation operation of the UE for the deactivated secondary serving cell is as follows. i) For the secondary serving cell, the UE stops the operation of a deactivation timer for the secondary serving cell. ii) For the DL SCC corresponding to the secondary serving cell, the UE stops monitoring of the PDCCH for the control region of the secondary serving cell. This includes the case in which the UE stops the PDCCH monitoring operation of the control region established for the secondary serving cell scheduling within the overall control region in the secondary serving cell established for cross component carrier scheduling (CCS). The UE dose not ‘receive’ the information on the downlink and uplink resource assignment in the secondary serving cell. The UE dose not react to the downlink and uplink resource assignment in the secondary serving cell. Here, the ‘react’ may include the transmission of ACK/NACK information that means the receive success or the receive failure of the information on the resource assignment. The UE does not process the downlink and uplink resource assignment to the secondary serving cell. For example, the ‘process’ may include both of the ‘receive’ and ‘react’ operations.

iii) For the UL SCC corresponding to the secondary serving cell, the UE stops the transmission of the periodic SRS and the aperiodic SRS. In addition, the UE stops channel quality information (CQI) report. Further, the UE stops the transmission or the retransmission of the PUSCH.

The activation operation of the UE of the activated secondary serving cell performs all the operations that stop in the deactivation operation. The activation operation includes the uplink activation operation and the downlink activation operation. For example, the downlink activation operation includes an operation of allowing the UE to start the deactivation timer for the secondary serving cell, perform the monitoring of the PDCCH for the control region of the secondary serving cell for the DL SCC corresponding to the secondary serving cell, or to process for the downlink and uplink resource assignment for the secondary serving cell. Alternatively, the uplink activation operation includes an operation of allowing the UE to perform the transmission of the uplink signal. For example, the UE performs the transmission of the periodic SRS and the aperiodic SRS for the UL SCC corresponding to the secondary serving cell or performs the report of the channel quality information. Alternatively, the uplink activation operation includes an operation of allowing the UE to transmit or retransmit the PUCSCH.

The message for the activation operation (or the deactivation operation) may be transmitted in the medium access control (MAC) message type. For example, the MAC message includes the MAC sub-header and the MAC component. Here, the MAC sub-header includes a logical channel identifier (LCID) field that indicates that the corresponding MAC component is an MAC component indicating the activation or the deactivation of the serving cell. An example of the contents indicated by the LCID field value is shown in the following Table 1.

TABLE 1

| LCID Index | LCID Value |
|---|---|
| 00000 | CCCH |
| 00001-01010 | Identifier of Logical Channel |
| 01011-11010 | Reserved |
| 11011 | Activation/Deactivation |
| 11100 | UE Contention Resolution Identifier |
| 11101 | Timing Advance Command (TAC) |
| 11110 | DRX Command |
| 11111 | Padding |

Referring to Table 1, when the LCID value is 11011, the corresponding MAC control component is the MAC component that indicates the activation or the deactivation of the serving cell.

The MAC component indicating the activation or the deactivation of the serving cell has an octet structure of 8 bits and may indicate the activation or the deactivation of each serving cell in a bitmap format. Further, the positions of each bit are mapped to the serving cells of the specific index one-to-one. For example, the least significant bit (LSB) may be mapped to the serving cell of index 0 and the most significant bit (MSB) may be mapped to the serving cell of index 7. Alternatively, the least significant bit may mean the cell index of the primary serving cell. In this case, the bit mapped to the primary serving cell does not have a meaning of the activation or the deactivation. When bit is ‘0’, the serving cell corresponding to the bit may indicate the deactivation and when bit is ‘1’, the serving cell corresponding to the bit may indicate the activation. Meanwhile, the bit information of the position mapped to the secondary serving cell that is not configured in the UE is not considered or is disregarded by the UE and may be uniformly set to be the specific value, for example, ‘0’ by the eNB.

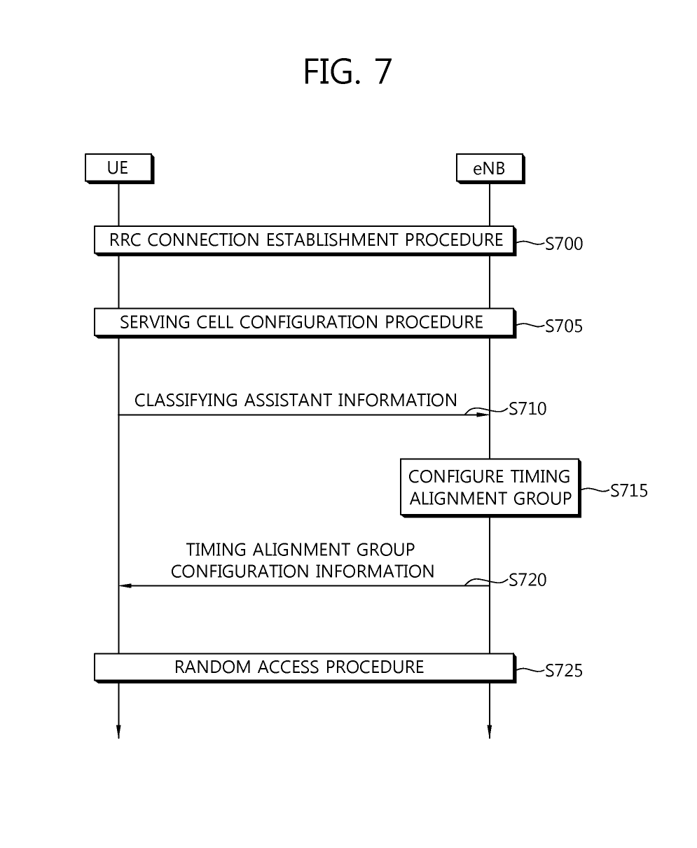

Meanwhile, the method for performing uplink synchronization is preconditioned that the specific serving cells are configured in the UE and each serving cell is activated or deactivated and each serving cell may be classified in a timing alignment group unit. In order to satisfy the precondition, the procedures to be completed beforehand are required. FIG. 7 shows the procedures.

FIG. 7 is a flow chart for describing a method for performing a random access for applying multi-TA.

Referring to FIG. 7, when the UE that is the radio resource control (RRC) idle mode cannot aggregate the component carrier and only the UE that is the RRC connection mode can aggregate the component carrier, the UE selects the cell for the RRC establishment prior to the component carrier aggregation and performs the RRC connection establishment procedure for the eNB through the selected cell (S700). The RRC connection establishment procedure is performed by allowing the UE to transmit the RRC connection request message to the eNB, the eNB to transmit the RRC connection setup to the UE, and the UE to transmit the RRC connection setup complete message to the eNB. The RRC connection establishment procedure includes SRB1 establishment.

Meanwhile, the cell for the RRC establishment is selected based on the following selection conditions.

(i), the UE may select the most suitable cell that attempts the RRC establishment based on measured information. The UE considers both of the RSRP that measures the receiving power based on the cell-specific reference signal (CRS) of the received specific cell and the RSRQ defined by a ratio of the overall receiving power (numerator) to the RSRP value (denominator) for the specific cell, as the measured information. Therefore, the UE acquires the RSRP and RSRQ values for each distinguishable cell and thus, selects the suitable cells based on the acquired RSRP and RSRQ values. For example, both of the RSRP and RSRQ values have a value of 0 dB or more, weights are assigned (for example, 7:3) to a cell in which the RSRP value is maximal or a cell in which the RSRQ value is maximal or each of the RSRP and RSRQ values, and the suitable cell may be selected based on an average value considering the weights.

(ii) In a system that is stored in the UE internal memory, the RRC establishment may be attempted using the information on the public land mobile network (PLMN) that is fixedly set, the downlink central frequency information, or the cell division information (for example, physical cell ID (PCI)). The stored information may configure of the information on the plurality of public land mobile networks and cells and priority or preferred weights may be set to each information.

(iii) The UE may receive the system information transmitted through the broadcasting channel from the eNB and confirm the information within the received system information to attempt the RRC establishment. For example, the UE confirms whether the specific cell (for example, closed subscribe group (CSG), non-allowed Home eNB, and the like) requires membership for cell connection. Therefore, the UE receives the system information transmitted by each eNB to confirm CSG ID information indicating the CSG or not. Further, in the case of the CSG, it confirms the accessible CSG or not. In order to confirm the accessibility, the UE may use its own membership information and the unique information (for example, evolved-cell global ID (E-CGI) or PCI information within the system information) of the CSG cell. When the eNB is confirmed as the non-accessible eNB through the confirmation procedure, the RRC establishment is not attempted.

(iv) The RRC establishment can be attempted through the valid component carriers (for example, the component carriers that can be configured within the supportable frequency band on implementation by the UE) that are stored in the internal memory of the UE.

Conditions (ii) and (iv) among the four selection conditions are optionally applied or conditions (i) and (iii) are to be mandatorily applied.

In order to attempt the RRC establishment through the cell selected for the RRC establishment, the UEi needs to confirm the uplink band transmitting the RRC connection request message. Therefore, the UE receives the system information through the broadcasting channel transmitted through the downlink of the selected cell. System information block 2 (SIB2) includes the bandwidth information and the central frequency information on the band to be used as the uplink. Therefore, the UE attempts the RRC connection through the uplink band that is connection-established through the downlink of the selected cell and the information within the SIB2. In this case, the UE may transmit the RRC connection request message as the uplink data to the eNB through the random access procedure. When the RRC connection procedure is successful, the RRC connection-established cell may be referred to the primary serving cell, wherein the primary serving cell is configured of the DL PCC and the UL PCC.

The eNB performs the RRC connection reconfiguration procedure for additionally configuring at least on secondary serving cell (SCell) in the UE when more radio resources are allocated to the UE by the request of the UE, the request of the network, or the determination of the eNB (S705). The RRC connection reconfiguration procedure is performed by allowing the eNB to transmit the RRC connection reconfiguration message to the UE and the UE to transmit the RRC connection reconfiguration complete message to the eNB.

The UE transmits classifying assistant information to the eNB (S710). The classifying assistant information provides the information or the criterion required to classify at least one serving cell configured in the UE into the timing alignment group. For example, the classifying assistant information may include at least one of geographical position information of the UE, neighbor cell measurement information, network deployment information, and serving cell configuration information. The geographical position information of the UE indicates the position that can be represented by latitude, a longitude, a height, and the like. The neighbor cell measurement information of the UE includes the RSRP of the reference signal or the RSRQ of the reference signal, which is transmitted from the neighbor cell. The network deployment information is information that indicates the deployment of the eNB, a frequency selective repeater (FSR), or a remote radio head (RRH). The serving cell configuration information is the information on the serving cell configured in the UE. In S710, the UE transmits the classifying assistant information to the eNB, but the eNB may separately know and previously hold the classifying assistant information. In this case, the random access according to the exemplary embodiment of the present invention may be performed in the state which the S710 is omitted.

The eNB classifies the serving cells to configure a timing advancing group (TAG) (S715). The serving cells may be classified or configured each TAG according to the classifying assistant information. The timing advancing group is a group including at least one serving cell and the same timing alignment value is applied to the serving cells within the timing advance group. For example, when the first serving cell and the second serving cell belong to the same timing advance group TAG1, the same timing alignment value TA1 is applied to the first serving cell and the second serving cell. On the other hand, when the first serving cell and the second serving cell belong to other timing advance groups TAG1 and TAG2, other timing alignment values TA1 and TA2 each are applied to the first serving cell and the second serving cell. The timing advance group may include the primary serving cell, may also include at least one primary serving cell, and may also include at least one secondary serving cell.

The eNB transmits the TAG configuration information to the UE (S720). At least one serving cell configured in the UE is classified into the timing advance group. That is, the TAG configuration information describes the state in which the TAG is configured. As the example, the TAG establishment information may include the number field of the TAG, the index field of each TAG, and the index field of the serving cell included in each TAG, wherein these fields describe the state in which the TAG is configured.

As another example, the TAG configuration information may further include the representative serving cell information within each TAG. The representative serving cell is a serving cell that may perform the random access procedure for holding and setting the uplink synchronization within each TAG. The representative serving cell may be referred to as a special SCell or a reference SCell. Unlike the above exemplary embodiment, when the TAG configuration information does not include the representative serving cell, the UE may select the representative serving cell within each TAG itself.

The UE performs the random access procedure on the eNB (S725). The UE performs the random access procedure on the representative serving cell based on the TAG configuration information. Here, the random access procedure for the secondary serving cell may start by allowing the eNB to order the random access procedure. In this case, the random access procedure may be processed only after the representative serving cell is activated. In other words, the random access procedure for the activated secondary serving cell may start by the PDCCH command transmitted by the eNB. In this case, the PDCCH command is assigned and transmitted to the control information region of the secondary serving cell that processes the random access procedure. In addition, there may be the corresponding secondary serving cell and other secondary serving cells or primary serving cells, including an indicator indicating the secondary serving cell. Here, the random access procedure is based on the non-contention but may be processed based on the contention by the eNB′ intention.

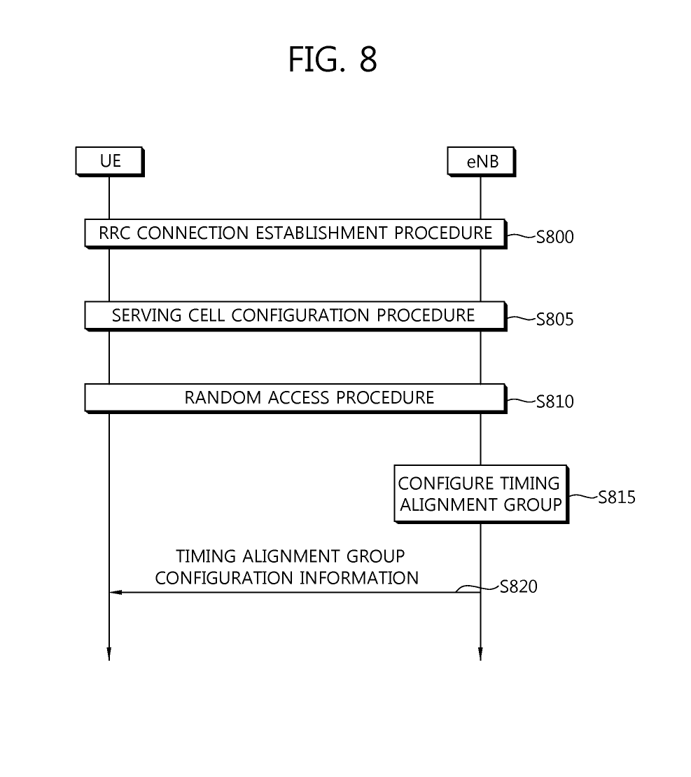

FIG. 8 is another flow chart for describing a method for performing a random access for applying multi-TA.

Referring to FIG. 8, when the UE that is the RRC idle mode cannot aggregate the component carrier and only the UE that is the RRC connection mode can aggregate the component carrier, the UE selects the cell for the RRC connection prior to the component carrier aggregation and performs the RRC connection establishment procedure on the eNB through the selected cell (S800). As described in S700 of FIG. 7, the RRC connection establishment procedure is performed by allowing the UE to transmit the RRC connection request message to the eNB, the eNB to transmit the RRC connection setup to the UE, and the UE to transmit the RRC connection setup complete message to the eNB. In this case, the serving cell used for the RRC connection establishment becomes the primary serving cell.

The eNB performs the RRC connection reconfiguration procedure for additionally configuring at least on secondary serving cell in the UE when more radio resources are allocated to the UE by the request of the UE, the request of the network, or the determination of the eNB (S805). As described above in S705 of FIG. 7, the RRC connection reconfiguration procedure is performed by allowing the eNB to transmit the RRC connection reconfiguration message to the UE and the UE to transmit the RRC connection reconfiguration complete message to the eNB.

The UE performs the random access procedure on the eNB (S810). The UE performs the random access procedure the secondary serving cell in which the uplink synchronization is not secured or on the secondary serving cell that is newly added, changed, and configured. Here, the random access procedure on the secondary serving cell may start only when the eNB orders the random access procedure. In this case, the random access procedure may be processed only after that secondary serving cell is activated. In other words, the random access procedure for the activated secondary serving cell may start by the PDCCH command transmitted by the eNB. In this case, the PDCCH command is assigned and transmitted to the control information region of the secondary serving cell that processes the random access procedure. In addition, the indicator indicating the secondary serving cell may also be included. Here, the random access procedure is based on the non-contention but may be processed based on the contention by the eNB′ intention.

The eNB classifies the serving cell to configure the TAG (S815). The serving cells may be classified into or configured of each TAG according to the random access preamble received during the random access procedure. The inter-serving cell group setting may be cell-specific according to the carrier aggregation (CA) condition. For example, when the serving cell served through the specific frequency band is served through the frequency selective repeater (FSR) or the RRH, the corresponding serving cells for all the UEs within the service area of the eNB and the serving cell directly served from the eNB are established so as to belong to different groups.

The eNB transmits the TAG configuration information to the UE (S820). At least one serving cell configured in the UE is classified into the timing advance group. That is, the TAG configuration information describes the state in which the TAG is configured. As the example, the TAG establishment information may include the number field of the TAG, the index field of each TAG, and the index field of the serving cell included in each TAG, wherein these fields describe the state in which the TAG is configured.

As another example, the TAG configuration information may further include the representative serving cell information within each TAG. Unlike the above exemplary embodiment, when the TAG configuration information does not include the representative serving cell, the UE may select the representative serving cell within each TAG itself.

Hereinafter, the method for performing a random access for applying the multi-TA according to the exemplary embodiment of the present invention will be described.

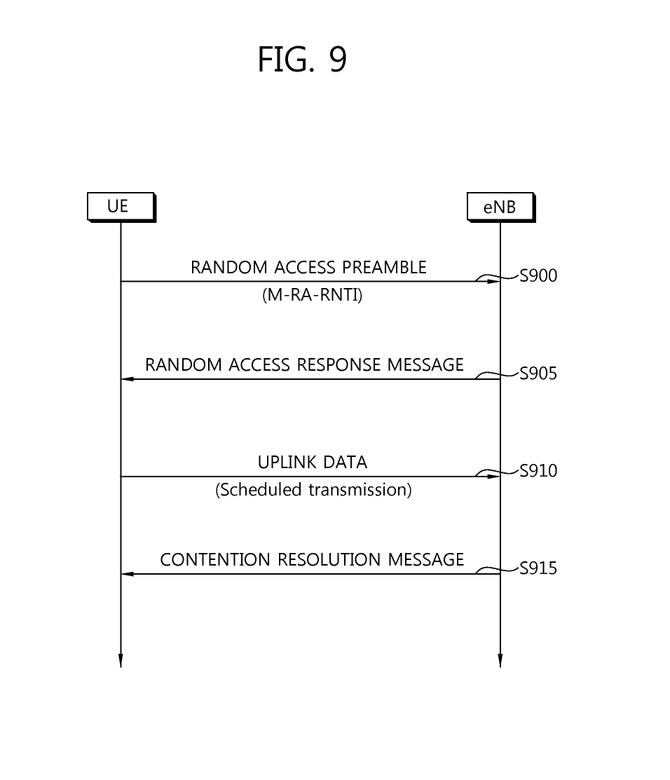

FIG. 9 is a flow chart for describing a random access procedure according to an example of the present invention. This is the contention based random access procedure.

The UE needs the uplink synchronization for transmitting and receiving data to and from the eNB. The UE may process a process of receiving information required for the synchronization from the eNB for the uplink synchronization. The random access procedure may be applied to the case in which the UE is newly coupled to the network through handover and may be processed in various conditions such as the synchronization after the UE is couple to the network, the change of the RRC state from the RRC idle state to the RRC connection state, and the like.

Referring to FIG. 9, the UE selects arbitrarily one preamble sequence from the set of the random access preamble sequences and transmits the random access preamble to the eNB according to the selected preamble sequence (S900).

Here, the UE may recognize a random access-radio network temporary identifier (RA-RNTI) in consideration of the temporarily selected frequency resource and the transmitting timing for transmission of the preamble selection and the random access channel (RACH).

The RA-RNTI, which is the identifier used for the PDCCH when the eNB transmits the random access response (RAR, or the random access response message), identifies the time/frequency resource used to transmit the random access preamble by the UE. The time/frequency resource indicates a specific preamble sequence ID.

The random access response message transmitted by the eNB for the random access preamble transmitted by the UE is transmitted to the UE through the PDSCH and the PDCCH serving to assign the resource of the corresponding PDSCH and designate the position thereof is scrambled by the RA-RNTI and thus, may be differentiated from the PDCCH having other RNTI value rather than the RA-RNTI. That is, in order to decode the PDCCH, the RA-RNTI values included in the UE and the eNB need to be the same.

Equation obtaining the RA-RNTI depends on the following Equation 2.

RA−RNTI=1+t_{id}+10×f_{id} [Equation 2]

In the above Equation, when RA-RNTI associated with the PRACH in which the Random Access Preamble is transmitted, t_{id} is an index of the first subframe of the specified PRACH (0≦t_{id}<10), and f_{id} is the index of the specified PRACH within that subframe, in ascending order of frequency domain (0≦f_{id}<6).

Meanwhile, when the random access procedure is additionally performed on the secondary serving cell, the RA-RNTI is required. However, in principle, a value corresponding to the RA-RNTI value of the PRACH configuration of the serving cell is not used for other RNTI (for example, C-RNTI, semi persistent scheduling (SPS) C-RNTI, temporary C-RNTI, TPC-PUCCH-RNTI, or TPC-PUSCH-RNTI). That is, there is no RNTI having the same value as the RA-RNTI value.

Therefore, in order to perform the multiple random access procedure on the secondary serving cell, a separate RA-RNTI having a value different from the RA-RNTI for the primary serving cell is required. To this end, in the exemplary embodiment of the present invention, a multiple random access RNTI (M-RA-RNTI) is defined and used. The random access to which the multi-TA is applied may be performed by transmitting the random access response message through the PDSCH indicated by the PDCCH generated by scrambling the M-RA-RNTI. The plurality of random accesses can be performed by using the plurality of M-RA-RNTIs.

As an example, the M-RA-RNTI may be generated through an predetermined offset value. Equation calculating the M-RA-RNTI depends on the following Equation 3.

M−RA−RNTI=1+t_{id}+10×f_{id}+m_{ta offset} [Equation 3]

The M-RA-RNTI further includes m_{ta offset} than the RA-RNTI. Here, the m_{ta offset} is an offset value, which the M-RA-RNTI and the RA-RNTI are differentiated from each other without having the same value. The m_{ta offset} may be adjusted so that the M-RA-RNTI has a value different from the RA-RNTI value. As an example, the m_{ta offset} may be 60. Since a maximum value of the RA-RNTI is 60 (when t_{id} is 9 and f_{id} is 5, RA-RNTI=1+9+10×5=60), the M-RA-RNTI has a value larger than 60 and does not have the same value as the RA-RNTI. As another example, the m_{ta offset} may have other values larger than 60. In addition, the plurality of M-RA-RNTI may be applied using different offsets. So, the predetermined offset value may be multiples of 60 in each serving cell.

As an example, the plurality of M-RA-RNTI values may have different offset values or each cell. For example, when t_{id} is 9 and f_{id} is 5, the M-RA-RNTI value for the first secondary serving cell may be M-RA-RNTI=1+9+10×5+60×1=120 and the M-RA-RNTI value for the second secondary serving cell may be M-RA-RNTI=RA-RNTI=1+9+10×5+60×2=180. In this case, the offset value in each cell is divided into a value equal to or larger than 60 so as not to overlap between the M-RA-RNTIs.

In order to provide different offset value for each cell, other values may be calculated based on the frequency index for each cell within the eNB. As the frequency index value, a physical cell index (or physical cell ID) or an E-UTRA absolute radio frequency channel number used in the RRC signaling may be used. When the corresponding value is too large and thus, exceeds the RNTI range, a value obtained through a modulo calculation with a proper value may be used. The modulo calculation means the rest calculation.

As another example, RNTI related offset value may be configured through information broadcasted in each secondary serving cell. Because the corresponding RNTI related offset value are different in each cell, RNTI values are configured not to overlap in each cell although t_{id} and f_{id} are changed. For example, if a offset value of a specific cell is configured as 60, a offset value of another cell is configured to 120 so that offset values are different from each other not regarding to t_{id} and f_{id}.

When f_{id} and t_{id} are different from each other in each cell, the M-RA-RANTI value may be defined based on the smallest values among several t_{id} values and f_{id} values. Therefore, the t_{id} value and the f_{id} value may be defined as one single for the single UE. As another example, each of the M-RA-RNTI values may be provided according to the corresponding f_{id} and t_{id} for each cell.

Meanwhile, the contention based preamble sequence for multi-TA may be mapped to the non-contention based preamble sequence in which the multi-TA is not supported. In a version in which the multi-TA is not supported, the signaling is performed to the non-contention based preamble sequence region, but in the UE or the eNB in which the multi TA is supported, the multi-TA contention based preamble sequence region may be separately divided within the corresponding non-contention based preamble sequence region.

The eNB transmits the random access response message as the response for the random access preamble to the UE (S905). In this case, the used channel is the physical downlink shared channel (PDSCH). The random access response message may be transmitted as a MAC protocol data unit (MAC PDU).

In this case, transmitting the random access response message through the PDSCH can be performed by the command of the PDCCH. Herein, the eNB may issue an order to the PDCCH generated by being scrambled by the RA-RNTI calculated based on the random access preamble transmission so as to transmit the random access response message.

According to the exemplary embodiment of the present invention, the RA-RNTI and the M-RA-RNTI can be calculated based on the random access preamble transmission and the eNB calculates the M-RA-RNTI when the random access procedure is performed for applying the multi-TA to the secondary serving cell. That is, the TA is applied to the primary serving cell by the RA-RNTI and the TA may be applied to each of the secondary serving cells by the M-RA-RNTI.

The random access response message may include a random access preamble identifier (RAPID) that identifies the UEs performing the random access, an identifier for the eNB, the temporary identifier for the UE such as the temporary C-RNTI, the information on the time slot receiving the random access preamble of the UE, the uplink radio resource assignment information, or the TA information for the uplink synchronization of the UE. The random access preamble identifier is to identify the received random access preamble.

In order to apply the multi-TA, the eNB may transmit the plurality of TA information to the UE so as to perform the random access on each serving cell. The eNB may transmit the TA information on the primary serving cell and the secondary serving cell. The plurality of TA information on the primary serving cells and the secondary serving cells may be transmitted by being included in the random access response message. For the plurality of TA information, the eNB may differentiate the UE through the preamble sequence, and the like. The cell index or the frequency index may differentiate the serving cell to which the TA information is applied. Unlike the cell index that may be differently set for each UE, all the UEs recognize the same frequency index for the corresponding eNB. As an example, as the frequency index, the physical cell ID may be used. Meanwhile, if random access response does not include multiple TA information, cell index or frequency index may not be used.

As described above, the timing information for the uplink synchronization is received through the random access response message and the UE can perform the uplink synchronization with the eNB.

The UE performing the uplink synchronization transmits the uplink data to the eNB through the PUSCH at the scheduling timing determined based on the TA information (S910). The uplink data may include an RRC connection request, a tracking area update, a scheduling request, or buffer status reporting for data to be transmitted to the uplink by the UE. The uplink data may include the random access identifier and the random access identifier may include the temporary C-RNTI, the C-RNTI (the state included in the UE), the UE contention resolution identify, and the like.

The transmission of the random access preamble transmission of several UEs may collide during S900 to S910 and therefore, the eNB transmits to the UE the contention resolution (CR) message informing that the random access successfully ends (S915). The contention resolution means that the UE can know whether the contention fails or succeeds during the contention based random access process.

The contention resolution message may include the random access identifier, the UE identifier information, or the C-RNTI. The number of possible random access preambles is limited and thus, the contention is generated during the contention based random access process. Since the unique random access preamble cannot be assigned to all the UEs within the cell, the UE temporarily selects and transmits one random access preamble from the random access preamble set. Therefore, at least two UEs may select and transmit the same random access preamble through the same PRACH resource.

In this case, the transmission of the uplink data fails or the eNB successfully receives only the uplink data of the specific UE according to the position or the transmission power of the UEs. When the eNB successfully receives the uplink data, the eNB transmits the contention resolution message using the random access identifier included in the uplink data. The UE receiving its own random access identifier may know that the contention resolution succeeds. When the UE receives the contention resolution message, the UE conforms whether the contention resolution message belongs thereto. As a confirmation result, if it is determined that the contention resolution message belongs to the UE, the UE transmits ACK to the eNB and if it is determined that the contention resolution message belongs to other UEs, the UE does not transmit the response data. Further, even when the UE misses the downlink assignment or does not decode the message, the UE does not transmit the response data.

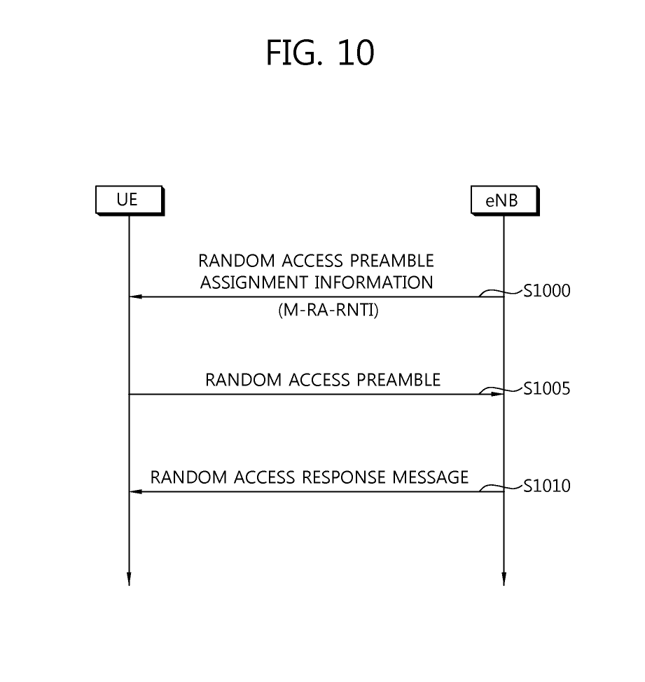

FIG. 10 is a flow chart for describing a random access procedure according to another exemplary embodiment of the present invention. This is the non-contention based random access procedure.

Referring to FIG. 10, the eNB selects one of the previously reserved dedicated random access preambles for the non-contention based random access procedure among all of the available random access preambles and transmits the random access preamble assignment information including the index and the available time/frequency resource information of the selected random access preamble to the UE (S1000). The UE is assigned with the dedicated random access preamble having no collision possibility from the eNB for the non-contention based random access process.

In addition, in order to perform the random access on the secondary serving cell, the random access preamble assignment information may be defined by the foregoing M-RA-RNTI for the eNB. The UE receiving the random access preamble assignment information can obtain the time/frequency resource used for the random access procedure for the secondary serving cell.

In connection with the RA-RNTI value and the M-RA-RNTI, in the content based random access procedure among the random access procedures performs a determination while seeing the preamble transmission position and the non-contention based random access procedure may determine the ordering process of the eNB.

As an example, when the random access process is performed during the handover process, the UE can obtain the dedicated random access preamble from the handover command message. As another example, when the random access process is performed by the request of the eNB, the UE can obtain the dedicated random access preamble through the PDCCH, that is, the physical layer signaling. In this case, the physical layer signaling is a downlink control information (DCI) format 1A and may include a field as shown in Table 2.

TABLE 2
Carrier indicator field (CIF) - 0 or 3 bits.
Flag for identifying format 0/1A - 1 bit (in case of 0, indicate format 0, in
case of 1, indicate format 1A).
When format 1A CRC is scrambled by C-RNTI, the rest fields are set
by the following, Format 1A is used for random access procedure
starting by the PDCCH order.
Below
Localized/Distributed VRB assignment flag - set as 1 bit. 0.
Resource block assignment - ┌log₂(N_{RB}^{DL}(N_{RB}^{DL} + 1)/2┐
bits. All the bits are set to be 1.
Preamble Index - 6 bits.
PRACH Mask Index - 4 bits.
All the rest bits of format 1A for simple scheduling assignment of one
PDSCH coding word are set to be 0.

Referring to Table 2, the preamble index is an index indicating one preamble selected from the previously reserved dedicated random access preambles for the non-contention based random access procedure and the PRACH mask index is the available time/frequency resource information. The available time/frequency resource information makes the ordering resource different according to the frequency division duplex (FDD) system and the time division duplex (TDD) system as shown in Table 3.

TABLE 3

| PRACH | | |
|---|---|---|
| MASK | | |
| INDEX | Allowed PRACH (FDD) | Allowed PRACH (TDD) |
| 0 | All | All |
| 1 | PRACH Resource Index 0 | PRACH Resource Index 0 |
| 2 | PRACH Resource Index 1 | PRACH Resource Index 1 |
| 3 | PRACH Resource Index 2 | PRACH Resource Index 2 |
| 4 | PRACH Resource Index 3 | PRACH Resource Index 3 |
| 5 | PRACH Resource Index 4 | PRACH Resource Index 4 |
| 6 | PRACH Resource Index 5 | PRACH Resource Index 5 |
| 7 | PRACH Resource Index 6 | Reserved |
| 8 | PRACH Resource Index 7 | Reserved |
| 9 | PRACH Resource Index 8 | Reserved |
| 10 | PRACH Resource Index 9 | Reserved |
| 11 | Every, in the time domain, | Every, in the time domain, even |
| | even PRACH opportunity | PRACH opportunity |
| | 1st PRACH Resource Index in | 1st PRACH Resource Index in |
| | subframe | subframe |
| 12 | Every, in the time domain, | Every, in the time domain, odd |
| | odd PRACH opportunity | PRACH opportunity |
| | 1st PRACH Resource Index in | 1st PRACH Resource Index in |
| | subframe | subframe |
| 13 | Reserved | 1st PRACH Resource Index in |
| | | subframe |
| 14 | Reserved | 2nd PRACH Resource Index in |
| | | subframe |
| 15 | Reserved | 3rd PRACH Resource Index in |
| | | subframe |

The UE transmits the selected dedicated random access preamble to the eNB based on the received information (S1005). The eNB can confirm from which UE the random access preamble is transmitted based on the received random access preamble and the time/frequency resource.

The eNB transmits the random access response message to the UE (S1010). The non-contention based random access response message may differentiate the UE or the serving cell to which the TA information is applied, including the cell index or the frequency index like the foregoing contention-based random access response message.

Meanwhile, unlike the contention based random access, the non-contention based random access includes the C-RNTI rather the temporary identifier of the UE like the temporary C-RNTI. The eNB may differentiate the UE to which the TA information is applied through the C-RNTI. Unlike the temporary C-RNTI, the C-RNTI indicates the specific UE and therefore, may be used as the information differentiating the UE.

The random access response message may be transmitted to the UE through the physical downlink control channel (PDSCH) ordered by the PDCCH scrambled by the cell-radio network temporary identifier (C-RNTI) of the UE.

In addition, the random access response message may be transmitted through the PDSCH by the ordering of the PDCCH scrambled based on the RA-RNTI or the M-RA-RNTI, wherein the RA-RNTI is calculated by the time/frequency resource information on whether the TA is applied to the primary serving cell and the M-RA-RNTI is calculated by the time/frequency resource information on whether the TA is applied to the secondary serving cell.

Unlike the contention based random access process, it is determined that the random access process is normally performed by receiving the random access response message during the non-contention based random access process and the random access process ends. The UE having the same RA-RNTI is only one and therefore, the CR procedure is not required.

When the preamble index within the preamble assignment information received by the UE is ‘000000’, the UE randomly selects one of the contention based random access preambles and after the PRACH mask index value is set to be ‘0’, the contention based procedure is processed. In addition, the preamble assignment information may be transmitted to the UE through the message of the upper layer (for example, mobility control information (MCI) within the handover command like the RRC.

Hereinafter, the detailed structure of the random access response message according to the exemplary embodiment of the present invention will be described.

The random access response message may be differentiated the MAC header, the MAC component, and padding. The MAC header is configured of the plurality of MAC sub-headers.

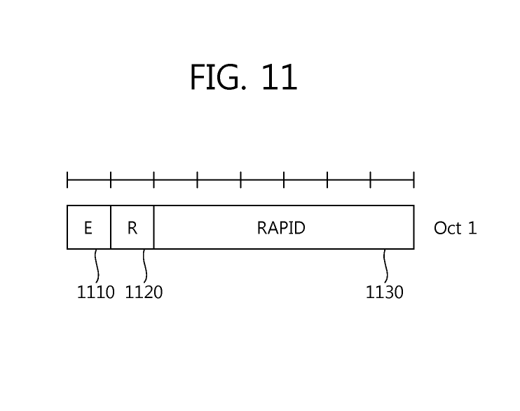

FIG. 11 is a diagram showing an example of a random access preamble ID (RAPID) MAC sub-header included in a random access response message according to an exemplary embodiment of the present invention. It may be applied to the non-contention based random access procedure without considering the backoff.

Referring to FIG. 11, an extension (E) field 1110 is a flag indicating whether another field is present within the MAC header. The E field has a ‘0’ value, which indicates that other fields are not present any more and the E field has a ‘1’ value, which indicates that other fields are present.

In the case of the non-contention random access procedure without considering the backoff, the MAC sub-header including a BI field is unnecessary and therefore, may not include a T field. Therefore, the MAC sub-header includes a reserved (R) field 1120, that is, includes the reserved bit and includes the RAPID field 1130 used to differentiate the transmitted random access preamble.

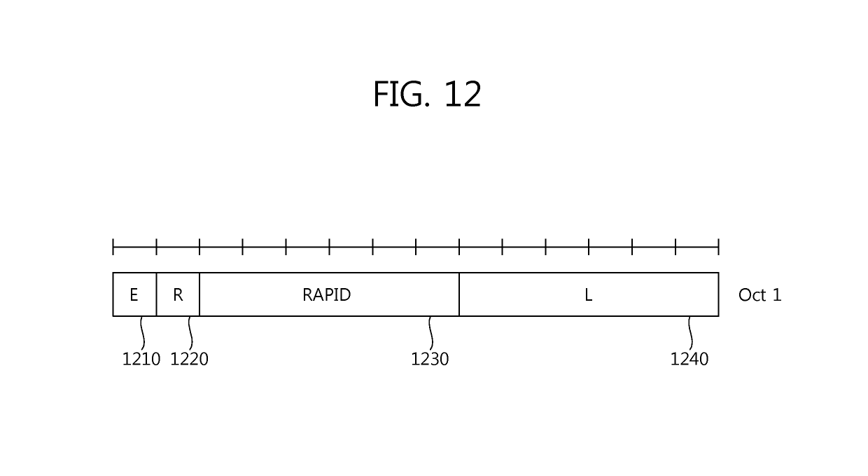

FIG. 12 is a diagram showing another example of a RAPID MAC sub-header included in a random access response message according to an exemplary embodiment of the present invention.

Referring to FIG. 12, the MAC sub-header includes an E field 1210 indicating whether another field is present within the MAC header and an RAPID field 1230 differentiating a reserved bit R field 1220 and a random access preamble.

In addition, the MAC sub-header further includes an L field 1240. The L field is a field indicating the length of the random access response MAC component indicated by the RAPID. A unit of the L field may be a byte, that is, 8 bits. A length of the L bit may be defined in the system.

In order to apply the multi-TA, the MAC component of the random response message transmitted from the eNB to the UE needs to include the plurality of TA fields. In this case, more bits than the existing MAC component is required.

For the existing backward compatibility, the transmission is made in a unit of a bundle of the MAC component and the MAC components each configuring the bundle of the MAC components are present in six octet unit. When the random access response MAC component is present in the 6 octet unit, it is inefficient due to a portion remaining without being used. However, the length of the MAC component may be transmitted through the MAC sub-header including the L field according to the exemplary embodiment of the present invention and therefore, the backward compatibility can be secured even though the random access response MAC component is present in the 6 octet unit. The reason is that the corresponding response MAC component is designated by the M-RA-RNTI, unlike the existing RA-RANTI. Therefore, the magnitude of the MAC component may be variably set.

Meanwhile, as shown in FIG. 11, when the MAC sub-header does not include the L field, it is possible to calculate the number of the TA field included in the MAC component through the cell index (or frequency index). The length of the MAC component can be derived based on the number of TA fields.

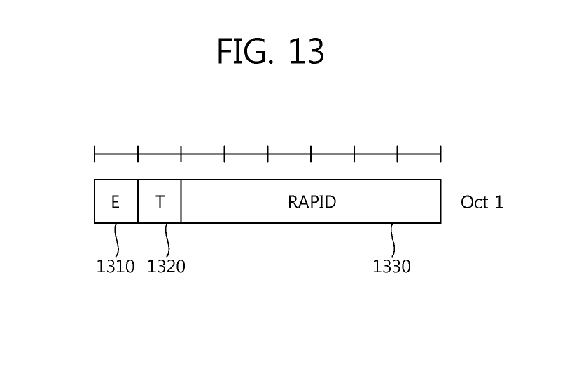

FIG. 13 is a diagram showing another example of a MAC sub-header included in a random access response message according to an exemplary embodiment of the present invention. It may be applied to the random access procedure considering the backoff.

Referring to FIG. 13, the MAC sub-header includes an E field 1310 and a RAPID 1330. In addition, the MAC sub-header includes a type (T) field 1320, wherein the T field is a flag indicating whether the MAC sub-header includes the RAPID or the backward ID. For example, when the T field has a ‘0’ value, it may indicate that the RAPID field is included and when the T field has a ‘1’ value, it may indicated that the Bl field is included.

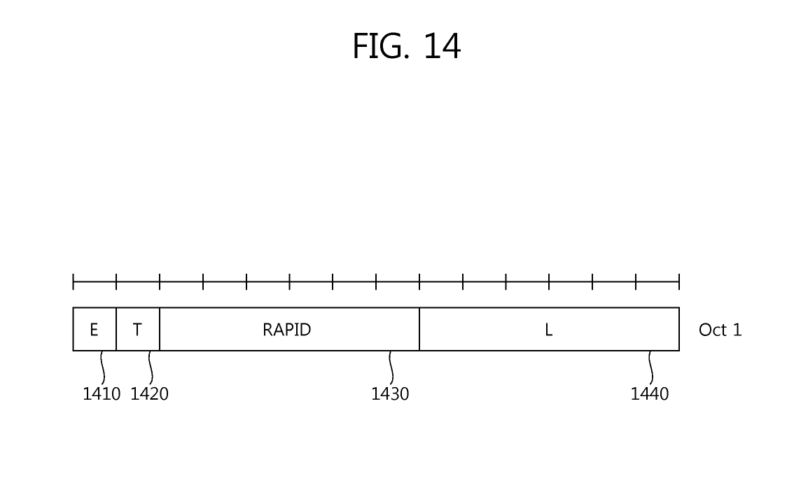

FIG. 14 is a diagram showing another example of a MAC sub-header included in a random access response message according to an exemplary embodiment of the present invention. It may be applied to the random access procedure considering the backoff.

Referring to FIG. 14, the MAC sub-header includes an E field 1410, a T field 1420, an RAPID field 1430, and an L field 1440 indicating the length of the random access response MAC component indicated by the RAPID.

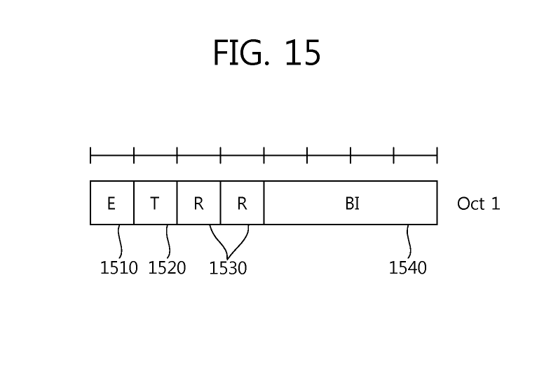

FIG. 15 is a diagram showing an example of a BI MAC sub-header included in a random access response message according to an exemplary embodiment of the present invention. It may be applied to the random access procedure considering the backoff.

Referring to FIG. 15, the MAC sub-header includes an E field 1510, a T field 1520, and an R field 1530. In addition, the MAC sub-header includes the BI field 1240, wherein the BI field is used to identify when the next random access is attempted according the overload state in the cell.

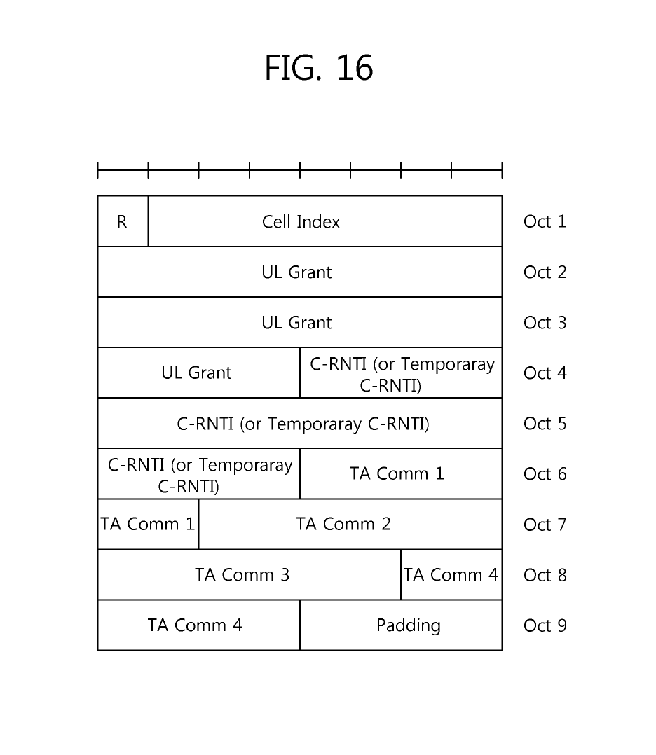

FIG. 16 is a diagram showing a structure of a MAC component included in a random access response message according to an exemplary embodiment of the present invention.

Referring to FIG. 16, the information on a response to each random access preamble is included. The timing advance command (TA command) field (or TA field) orders the adjustment required for the uplink transmission timing used for the timing synchronization, for example, 6 bits or 12 bits. The uplink grant (UL grant) field indicates the resource used for the uplink, for example, 20 bits. The temporary C-RNTI indicates the temporary identifier used by the UE for the random access and may be 16 bits.

In addition, the MAC component includes the cell index. The cell index includes the information on the serving cell to which the plurality of TA information is applied. The secondary serving cell may be ordered through the cell index. The cell index may be, for example, 7 bits. For example, each bit may indicate one of secondary serving cell 1 to secondary serving cell 7 other than the primary serving cell. As another example, the cell index may be 8 bits, which is a value from 0 to 7, wherein 0 means the primary serving cell.

The length of the MAC component may be ordered by the L field of the MAC sub-header.

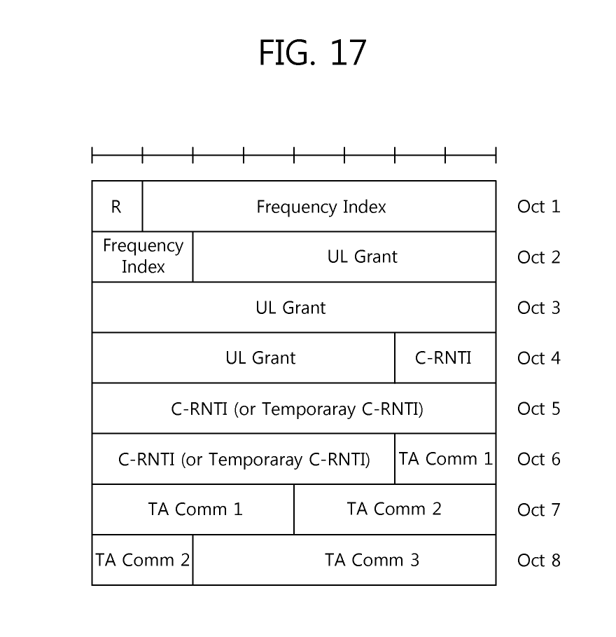

FIG. 17 is a diagram showing another example of a structure of a MAC component included in a random access response message according to an exemplary embodiment of the present invention.

Referring to FIG. 17, the MAC component includes the frequency index. The frequency index may indicate the secondary serving cell regarding the TA information used by the UE that is used for the uplink transmission. The frequency index may be, for example, the physical cell ID and the length thereof may be 9 bits.

The TA command field (or TA field) of the MAC component includes the TA information on the secondary serving cell indicated by the cell index or the frequency index, wherein the TA command field indicates the adjustment required for the uplink transmission timing used for the timing synchronization and may include the plurality of TA command fields. The magnitude may be, for example, 6 bits, but may be defined by the requirement of the system between 1 and 12.

In the case of the plurality of TA command fields, the index may be arranged in a descending order from the largest value and the index may be arranged in an ascending order from the smallest value. The number of TA command fields is equal to the number of values set to be 1 among the cell indexes (or frequency indexes).

In addition, the MAC component may include the C-RNTI (or temporary C-RNTI) field and the magnitude thereof may be 16 bits. Other portion may be padding.

In the non-contention based random access procedure, the MAC component regarding the secondary serving cell does not necessarily have the uplink grant field and therefore, may not include the uplink grant field. The C-RNTI (or temporary C-RNTI) is not necessarily included and therefore, may be omitted.

The TA command field orders the adjustment required for the uplink transmission timing used for the timing synchronization. For example, the TA command field may be 6 bits and may include the plurality of TA command fields. In the case of the plurality of TA command fields, the index may be arranged in a descending order from the largest value and the index may be arranged in an ascending order from the smallest value. The number of TA command fields is equal to the number of values set to be 1 among the indexes.

The length of the MAC component may be ordered by the L field of the MAC sub-header.

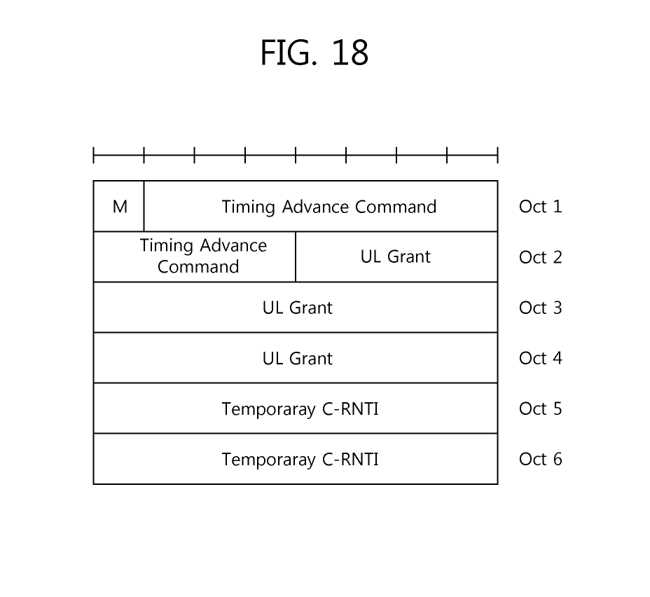

FIG. 18 is a diagram showing another example of a structure of a MAC component included in a random access response message according to an exemplary embodiment of the present invention.

As another example, when the plurality of M-RA-RNTI values are used, each M-RA-RNTI value may indicate the inter-cell differentiation and therefore, may have the structure of the MAC component in a type in which the cell index or the frequency index is not included in the structure of the MAC component.

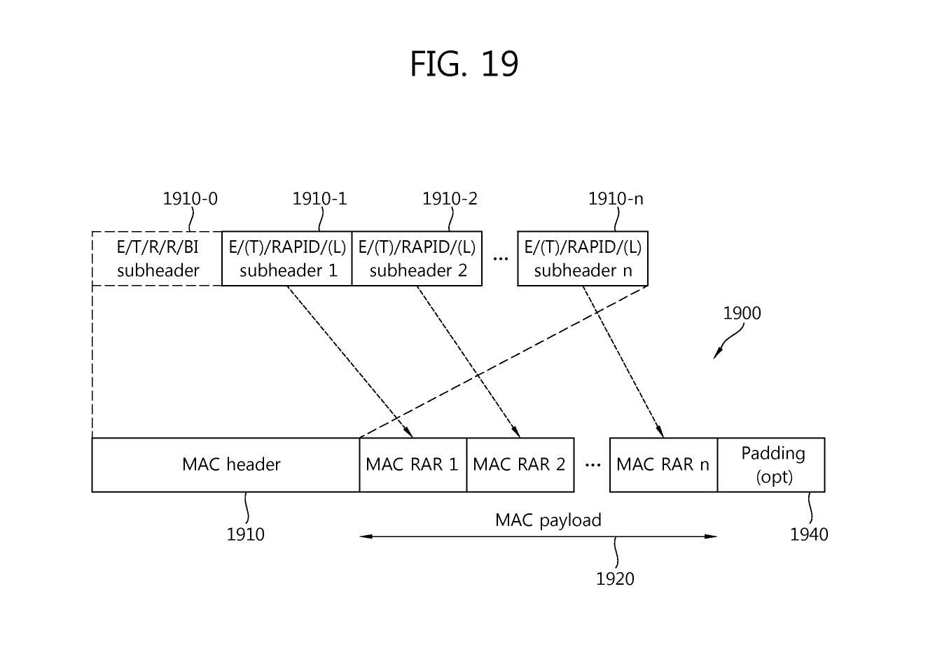

FIG. 19 is a diagram showing an MAC PDU structure for random access response and a mapping structure of RAPID and random access response.

Referring to FIG. 19, an MAC PDU 1900 includes an MAC header 1910 and an MAC payload 1920. The MAC payload 1920 includes at least one MAC random access response (MAC RAR). The MAC header includes at least one MAC subheader, wherein the MAC subheader is divided into an RAPID MAC sub-header and a backward indicator (BI) MAC sub-header. Each RAPID MAC sub-header corresponds to one MAC PAR. Optionally, it may include padding 1940.

The MAC header 1910 includes at least one sub-headers 1910-0, 1910-1, 1910-2, . . . , 1910-n, wherein each sub-header 1910-0, 1910-1, 1910-2, . . . , 1910-n corresponds to one MAC PAR. The sub-headers 1910-0, 1910-1, 1910-2, . . . , 1910-n is arranged in the same sequence as the corresponding MAC PARs within the MAC PDU 1900.

Each sub-header 1910-0, 1910-1, 1910-2, . . . , 1910-n includes five fields of E, T, R, R, and BI, three fields of E, T, and RAPID, or three fields of E, R, and RAPID and may include four fields of E, R, RAPID, and L or E, T, RAPID, and L. Since the BI field is unnecessary, the T field may not be present and the L field may be present so as to variably have the length of the MAC component for the plurality of TA information. The L field is omitted and the number of TA commands may be counted in the cell index.

The sub-header including five fields is the sub-header corresponding to the MAC header 1910 and the sub-header including three fields (or four fields) is a sub-header corresponding to the MAC PAR.

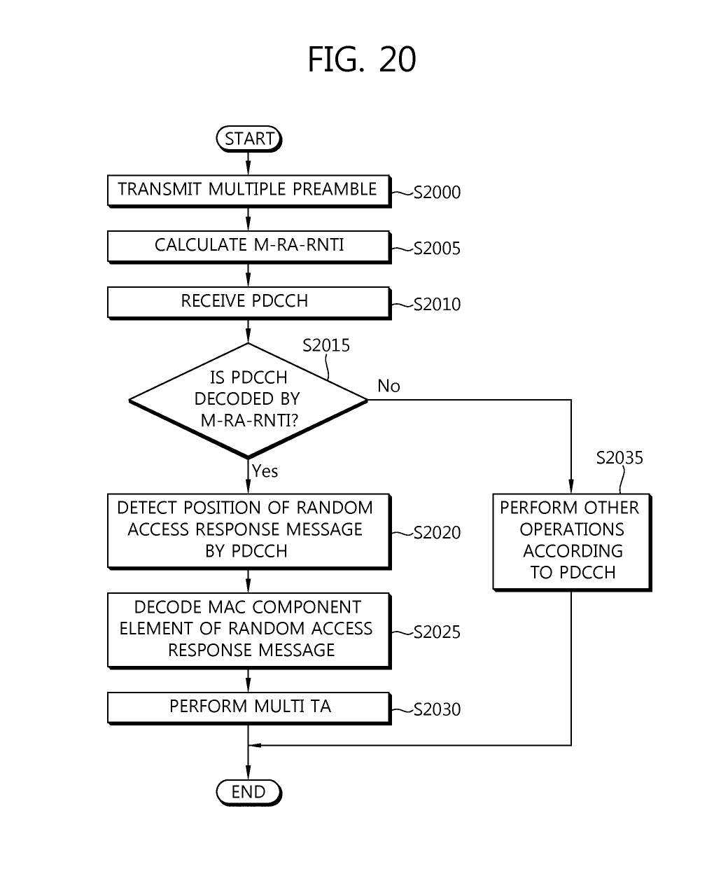

FIG. 20 is a diagram showing an operation flow chart of a terminal performing a random access procedure according to an exemplary embodiment of the present invention.

Referring to FIG. 20, the UE transmits the multiple random access preamble to the eNB (S2000). The UE may select arbitrarily one preamble sequence from the set of the random access preamble sequences and first transmit the random access preamble to the eNB according to the selected preamble sequence.

However, in the case of the non-contention based random access procedure, prior to S2000, the eNB selects one of the previously reserved dedicated random access preambles for the non-contention based random access procedure among all of the available random access preambles and transmits the random access preamble assignment information including the index and the available time/frequency resource information of the selected random access preamble to the UE. The UE is assigned with the dedicated random access preamble having no collision possibility from the eNB for the non-contention based random access process.

The UE calculates the multiple random access radio network temporary identifier (M-RA-RNTI) (S2005) and scrambles the M-RA-RNTI to receive the PDCCH (S2010). This is to receive the random access response message through the PDSCH by the ordering of the PDCCH. In order to perform the random access procedure on the secondary serving cell, the M-RA-RNTI separately from the RA-RNTI used in the random access procedure for the primary serving cell is used. As described in Equation 3, the M-RA-RNTI may be set using the offset value to have different values from the existing RA-RNTI. When the plurality of M-RA-RNTI is used, each of the M-RA-RNTI may be set to have different values using the offset value.

First, it is determined that the PDCCH is decoded by the M-RA-RNTI (S2015). The eNB may decode the PDCCH by making the calculated M-RA-RNTI value and the M-RA-RNTI value calculated by the UE equal to each other. If so, the UE detects and receives the position of the random access response message by the ordering of the PDCCH (S2020). The UE may transmit the random access response message received from the eNB as the response to the multiple random access preambles in the MAC PDU format. Further, the random access response message may include a random access preamble identifier (RAPID) that identifies the UEs performing the random access, an identifier for the eNB, the temporary identifier for the UE such as the temporary C-RNTI, the information on the time slot receiving the random access preamble of the UE, the uplink radio resource assignment information, or the TA information for the uplink synchronization of the UE.

The random access response information is acquired by decoding the MAC component of the random access response message in addition to the TA information (S2025). The UE performs the multi-TA based on the acquired TA information (S2030). The uplink synchronization with the eNB may be performed using the TA information and the cell index or the frequency index and in the case of the non-contention based random access, the UE may be used to differentiate the MAC component belong to the corresponding UE through the C-RNTI value included in the random access response message. Applying the TA value included in the TA command may be performed based on the uplink transmission of the main serving cell and may be performed based on each secondary serving cell uplink transmission regardless of the primary serving cell.

In S2015, the case in which the PDCCH is not decoded by the M-RA-RNTI does not correspond to the random response message for the multi-TA and therefore, performs the separate operation according to the PDCCH (S2035).

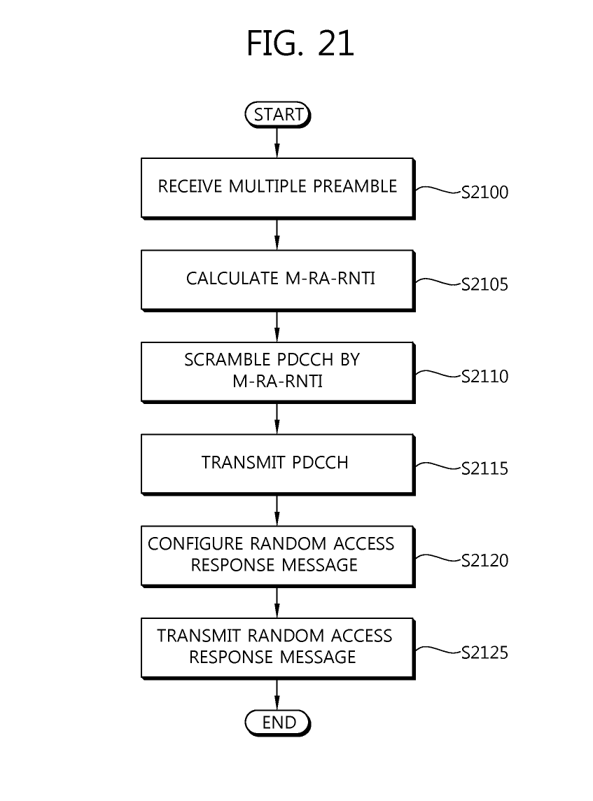

FIG. 21 is a diagram showing an operation flow chart of a base station performing a random access procedure according to an exemplary embodiment of the present invention.

Referring to FIG. 21, the eNB receives the multiple random access preambles from the UE (S2100). However, in the case of the non-contention based random access, prior to S2100, the eNB selects one of the previously reserved dedicated random access preambles for the non-contention based random access procedure among all of the available random access preambles and transmits the random access preamble assignment information including the index and the available time/frequency resource information of the selected random access preamble to the UE. For the non-contention based random access process of the UE, it is necessary to assign the dedicated random access preamble having no collision possibility.

Then, the eNB calculate the M-RA-RNTI (S2105). The eNB may decode the PDCCH by making the calculated M-RA-RNTI value and the M-RA-RNTI value calculated by the UE equal to each other.

When the value of the M-RA-RNTI calculated by the eNB is equal to the value of the M-RA-RNTI calculated by the UE, the eNB scrambles the PDCCH for the random response access message based on the M-RA-RNTI (S2110) and transmits the scrambled PDCCH to the UE (S2115).

The eNB configures the MAC sub-header and the MAC component of the random access response message to be transmitted to the UE (S2120). The random access response message may include a random access preamble identifier (RAPID) that identifies the UEs performing the random access, an identifier for the eNB, the temporary identifier for the UE such as the temporary C-RNTI, the information on the time slot receiving the random access preamble of the UE, the uplink radio resource assignment information, or the TA information for the uplink synchronization of the UE.

In particular, the MAC sub-header of the random access response message may include the identifier (or indicator) L field including the length information of the MAC component. When including the plurality of TA information for applying the multi-TA, the length of the MAC component may be long and the length of the MAC component is identified (or ordered) in the MAC sub-header to secure the backward compatibility.

For applying the multi-TA, the MAC component of the random access response message to perform the random access on each serving cell may include the plurality of TA information on the primary serving cells and the secondary serving cells.

In addition, the random access response message may be configured to include the cell index or the frequency index so as to differentiate the terminal and the serving cell to which the plurality of TA information is applied. The cell index or the frequency index may be configured to include the MAC component of the random access response.

The eNB transmits the random access response message to the UE (S2125). The random access response message may be transmitted through the PDSCH indicated by the PDCCH scrambled based on at least one random access radio network temporary identifier (RA-RNTI) for at least one serving cell, respectively. In order to perform the random access procedure on the secondary serving cell, the M-RA-RNTI separately from the RA-RNTI used in the random access procedure for the primary serving cell is used. As described in Equation 3, the M-RA-RNTI may be set using the offset value to have different values from the existing RA-RNTI. When the plurality of M-RA-RNTI is used, each of the M-RA-RNTI may be set to have different values using the offset value. The random access response message may be transmitted in the MAC PDU format.

Thereafter, the eNB may perform the uplink synchronization with the UE through the TA information and the cell index or the frequency index.

In the operation of the UE and the eNB shown in FIGS. 20 and 21, the random access preamble is transmitted from the UE to the eNB in each secondary serving cell requiring the TA and the transmission of the random access response message for the random access preamble is basically limited as being transmitted from the eNB to the UE in the primary serving cell. The reason is that the common search space region in which the PDCCH for the random response access message can be transmitted is defined only in the primary serving cell.

However, unlike this, when the common search space can be defined even in the secondary serving cell, the transmission of the random access response message can be also made in each secondary serving cell.

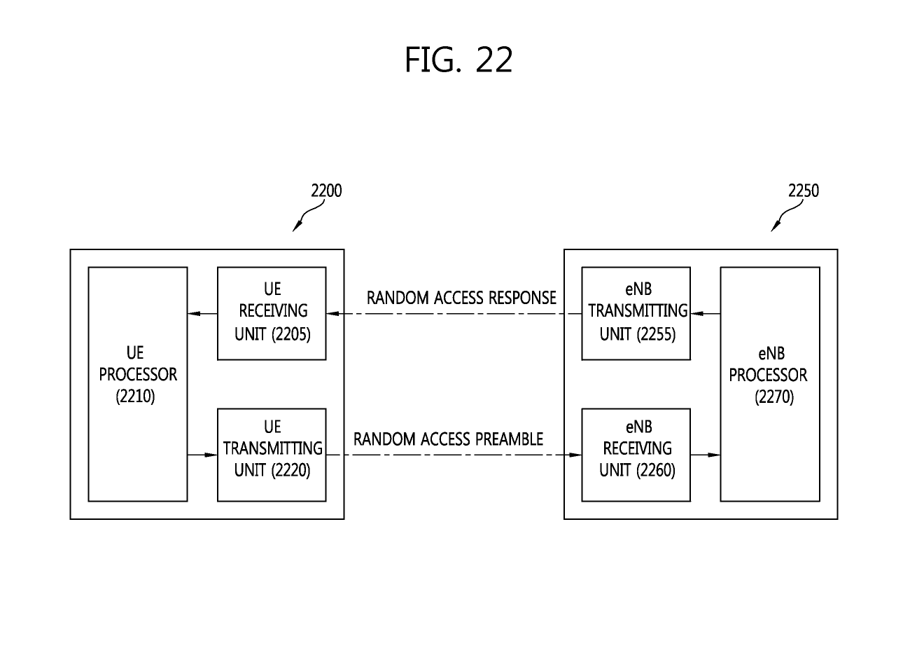

FIG. 22 is a block diagram showing an eNB and a terminal performing a random access according to an exemplary embodiment of the present invention.

Referring to FIG. 22, a UE 2200 includes a UE receiving unit 2205, a UE processor 2210, and a UE transmitting unit 2220.

The UE receiving unit 2205 may receive the preamble assignment information, the random message response message, the RRC connection establishment message, the RRC connection reconfiguration message, or the contention resolution message from the eNB 2250. The random access response message may include the MAC sub-header as shown in FIGS. 11 to 15 and the MAC component as shown in FIGS. 16 and 17. In this case, the MAC component may include the cell index or the frequency index.

In addition, the MAC sub-header may include the identifier (or indicator) L field representing the length of the MAC component and receive the MAC component based on the L field.

The random access response message is transmitted through the PDSCH indicated by the PDCCH. In this case, the PDCCH is scrambled based on the RA-RNTI and when the random access procedure is performed on the plurality of serving cells, different RA-RNTIs are set for each of the plurality of serving cells, the M-RA-RNTI is set for the secondary serving cell, and the M-RA-RNTI is set to have a value differentiated from the RA-RNTI using the predetermined offset as represented by in Equation 3.

The UE receiving unit 2205 receives a random access response as a response to the random access preamble through a physical downlink shared channel (PDSCH) indicated by a physical downlink control channel (PDCCH) scrambled by one or more random access radio network temporary identifier (RA-RNTI) including a predetermined offset value configured to have different values in each serving cell, respectively, from the eNB,

The processor 2210 processes the non-contention based or contention based random access procedure. In order to secure the uplink time synchronization for the serving cell, the random access preamble is generated. The generated random access preamble may be the dedicated random access preamble assigned by the eNB 2250.

The uplink time for each serving cell is adjusted by using the cell index or the frequency index for the plurality of received TA information within the random access response message received from the eNB.

The UE transmitting unit 2220 transmits the random access preamble to the eNB 2250.

The eNB 2250 includes an eNB transmitting unit 2255, an eNB receiving unit 2260, and an eNB processor 2270.

The eNB transmitting unit 2255 transmits the preamble assignment information, the random access response message, or the contention resolution message to the eNB 2200.

The random access response message is transmitted through the PDSCH indicated by the PDCCH. In this case, the PDCCH is scrambled based on the RA-RNTI and when the random access procedure is performed on the plurality of serving cells, different RA-RNTIs are set for each of the plurality of serving cells, the M-RA-RNTI is set for the secondary serving cell, and the M-RA-RNTI is set to have a value differentiated from the RA-RNTI using the predetermined offset as represented by in Equation 3.

The eNB transmitting unit 2255 transmits a random access response as a response to the random access preamble through a physical downlink shared channel (PDSCH) indicated by a physical downlink control channel (PDCCH) scrambled by one or more random access radio network temporary identifier (RA-RNTI) including a predetermined offset value configured to have different values in each serving cell, respectively, to the UE,

The eNB receiving unit 2260 receives the random access preamble from the UE 2200.

The eNB processor 2270 selects one of the previously reserved dedicated random access preambles for the non-contention based random access procedure among the available random access preambles and generates the preamble assignment information including the index and the available time/frequency resource information of the selected random access preamble. In addition, the random access response message or the contention resolution message is generated.

In addition, the TA information transmitted to the UE is configured and the random access response message including the cell index or the frequency index is generated. For example, the cell index or the frequency index may be configured to be included in the MAC component of the random access response message. An example of the MAC component is described in FIGS. 16 and 17.

In addition, when the length of the MAC component including the plurality of TA information is longer than 6 octet, it may be configured to identify (or indicate) the length of the MAC component, including the L field in the MAC sub-header.

The TA command indicates the change of the relative uplink time to the current uplink time and may be an integer multiple of the sampling time Ts, for example, 16 Ts. The TA command may be represented by the timing alignment value of the specific index.

The spirit of the present invention has been just exemplified. It will be appreciated by those skilled in the art that various modifications and alterations can be made without departing from the essential characteristics of the present invention. Accordingly, the embodiments disclosed in the present invention and the accompanying drawings are used not to limit but to describe the spirit of the present invention. The scope of the present invention is not limited only to the embodiments. The protection scope of the present invention must be analyzed by the appended claims and it should be analyzed that all spirits within a scope equivalent thereto are included in the appended claims of the present invention.

1. A method for performing a random access by a user equipment (UE) in a wireless communication system, comprising:
transmitting a random access preamble to an evolved-NodeB (eNB); and
receiving a random access response from the eNB as a response to the random access preamble,
wherein the random access response is transmitted through a physical downlink shared channel (PDSCH) indicated by a physical downlink control channel (PDCCH) scrambled by one or more random access radio network temporary identifiers (RA-RNTIs), and
the one or more RA-RNTIs include a predetermined offset value configured to have different values in each serving cell, respectively.

2. The method of claim 1, wherein the predetermined offset value is configured based on a frequency index of a serving cell.

3. The method of claim 2, wherein the frequency index is a physical cell identification (ID) or absolute radio frequency channel number.

4. The method of claim 2, wherein the predetermined offset value is configured as a result of modulo calculation of the frequency index of the serving cell.

5. The method of claim 1, wherein the predetermined offset value is included in Radio Resource Control connection reconfiguration information received through a primary serving cell and applied in each serving cell

6. The method of claim 1, wherein the predetermined offset value is received by information broadcast through each secondary serving cell.

7. The method of claim 1, wherein the one or more RA-RNTIs are calculated according to the following Equation,
RA-RNTI=1+t+10f+offset, [Equation]
where, t is an index of the first subframe of a physical random access channel (PRACH) in which the random access preamble is transmitted, and f is an index of the PRACH within that subframe, in ascending order of frequency domain, and the offset is the predetermined offset value.

8. The method of claim 1, wherein the predetermined offset value is set to 0 in a primary serving cell, and set to multiples of 60 in each secondary serving cell.

9. A user equipment to perform a random access in a wireless communication system, comprising:
a transmitting unit to transmit a random access preamble to an evolved-NodeB (eNB); and
a receiving unit to receive, from the eNB, a random access response as a response to the random access preamble through a physical downlink shared channel (PDSCH) indicated by a physical downlink control channel (PDCCH) scrambled by one or more random access radio network temporary identifiers (RA-RNTIs) including a predetermined offset value configured to have different values in each serving cell, respectively.

10. A method for performing a random access by an evolved-NodeB (eNB) in a wireless communication system, comprising:
receiving a random access preamble from a User Equipment (UE); and
transmitting a random access response to the UE as a response to the random access preamble,
wherein the random access response is transmitted through a physical downlink shared channel (PDSCH) indicated by a physical downlink control channel (PDCCH) scrambled by one or more random access radio network temporary identifiers (RA-RNTIs), and
the one or more RA-RNTIs include a predetermined offset value configured to have different values in each serving cell, respectively.

11. The method of claim 10, wherein the predetermined offset value is configured based on a frequency index of a serving cell.

12. The method of claim 11, wherein the frequency index is a physical cell identification (ID) or absolute radio frequency channel number.

13. The method of claim 11, wherein the predetermined offset value is configured as a result of modulo calculation of the frequency index of the serving cell.

14. The method of claim 10, wherein the predetermined offset value is included in Radio Resource Control connection reconfiguration information received through a primary serving cell and applied in each serving cell.

15. The method of claim 10, wherein the predetermined offset value is received by information broadcast through each secondary serving cell.

16. The method of claim 10, wherein the one or more RA-RNTIs are calculated according to the following Equation,
RA-RNTI=1+t+10f+offset, [Equation]
where, t is an index of the first subframe of a physical random access channel (PRACH) in which the random access preamble is transmitted, and f is an index of the PRACH within that subframe, in ascending order of frequency domain, and the offset is the predetermined offset value.

17. The method of claim 10, wherein the predetermined offset value is set to 0 in a primary serving cell, and set to multiples of 60 in each secondary serving cell.

18. An evolved-NodeB (eNB) to perform a random access in a wireless communication system, comprising:
a receiving unit to receive a random access preamble from a User Equipment (UE); and
a transmitting unit to transmit, to the UE, a random access response as a response to the random access preamble through a physical downlink shared channel (PDSCH) indicated by a physical downlink control channel (PDCCH) scrambled by one or more random access radio network temporary identifiers (RA-RNTIs) including a predetermined offset value configured to have different values in each serving cell, respectively.
